(19) United States
(12) Patent Application Publication
(10) Pub. No.: US 2025/0086917 A1
(43) Pub. Date: Mar. 13, 2025

(54) INFORMATION PROCESSING SYSTEM, STORAGE MEDIUM, INFORMATION PROCESSING APPARATUS, AND INFORMATION PROCESSING METHOD

(71) Applicant: NINTENDO CO., LTD., Kyoto (JP)

(72) Inventors: Tsubasa SAKAGUCHI, Kyoto (JP); Yusuke AMANO, Kyoto (JP); Masaki WADA, Kyoto (JP); Shinya YANO, Kyoto (JP)

(21) Appl. No.: 18/826,725

(22) Filed: Sep. 6, 2024

(30) Foreign Application Priority Data
Sep. 7, 2023 (JP) 2023-145520

(51) Int. Cl. G06T 19/20; A63F 13/493

(52) U.S. Cl. CPC G06T 19/20; A63F 13/493; G06T 2219/2004

(57) ABSTRACT

A state of a virtual space including at least a plurality of first objects is changed based on a user's input. In the virtual space, a region having an extent in a horizontal direction set based on a height in the virtual space at which a second object associated with the user is arranged based on the user's input, and including a position related to a horizontal direction of the second object, is set as a first region related to the user. A limitation is imposed on changing of the state of the virtual space in the first region without the user's input to change the state of the virtual space being performed.

### CROSS REFERENCE TO RELATED APPLICATION

This application claims priority to Japanese Patent Application No. 2023-145520, filed on Sep. 7, 2023, the entire contents of which are incorporated herein by reference.

### FIELD

The technology disclosed herein relates to information processing systems, storage media, information processing apparatuses, and information processing methods that perform processing using a player character in a virtual space.

### BACKGROUND AND SUMMARY

There has conventionally been a game system in which a player character is allowed to set an area at any position in a virtual space based on a user's operation to limit other characters' actions in the area.

However, in the above game system, the user's operation for setting an area in a virtual space may be cumbersome.

With the above in mind, the present example provides an information processing system, storage medium, information processing apparatus, and information processing method that are capable of optimizing a user's operation required for setting of an area in a virtual space.

The present example may have features (1) to (20) below, for example.

(1) An example configuration of an information processing system according to the present example is an information processing system comprising: one or more processors; and one or more memories storing a program that, when executed, causes the information processing system to perform operations including: changing a state of a virtual space including at least a plurality of first objects by performing at least one of arrangement, movement, and removal of at least one of the first objects and a second object that is associated with each user, at, to, and from a position in the virtual space specified based on a user's input; setting, in the virtual space, a region having an extent in a horizontal direction set based on a height in the virtual space at which the second object associated with the user is arranged based on the user's input, and including a position related to the horizontal direction of the second object, as a first region related to the user (e.g., with the region being a two-dimensional or three-dimensional region); and limiting changing of the state of the virtual space in the first region without the user's input to change the state of the virtual space being performed.

With the configuration of (1), the first region in which changing of the state of the virtual space is limited can be set based on the user's input to arrange the second object. Therefore, the number of times the user performs an operation required for setting the region in the virtual space can be reduced.

(2) In the configuration of (1), the setting the first region may include setting the first region such that the extent increases as the second object is arranged at a greater height in the virtual space.

With the configuration of (2), the extent of the first region can be estimated from the height in the virtual space at which the second object is arranged.

(3) In the configuration of (1) or (2), the limiting may include limiting further changing of the state of the virtual space in the first region that occurs when the second object is arranged, or the state of the virtual space in the first region after being changed based on the user's input.

With the configuration of (3), a limitation can be imposed on further changing of the state that occurs when the second object is arranged, or the state after changing.

(4) In the configuration of (1), further, a state of a virtual space that is the same as the virtual space including at least the plurality of first objects may be changed by performing at least one of arrangement, movement, and removal of at least one of the first and second objects at, to, and from a position in the virtual space specified based on an input performed by another user that is different from the user. The limiting may include limiting changing of the state of the virtual space in the first region based on the another user's input.

With the configuration of (4), in the virtual space, a region in which the state is not changed by the another user's operation can be ensured.

(5) In the configuration of (4), the limiting may include limiting arrangement of at least one of the first and second objects in the first region based on the another user's input.

With the configuration of (5), in the virtual camera, a region in which none of the first and second objects is arranged by the another user's operation can be ensured.

(6) In the configuration of (5), the setting the first region may include setting the first region such that the extent increases as the second object is arranged at a greater height in the virtual space, and a position in a vertical direction in the virtual space at which the second object is arranged is included in the first region.

With the configuration of (6), in the virtual space, a region in which another object is not arranged above or below the second object by the another user's operation can be ensured.

(7) In the configuration of any one of (4) to (6), the limiting may include limiting removal of at least one of the first and second objects in the first region based on the another user's input.

With the configuration of (7), in the virtual space, a region in which none of the first and second objects is removed by the another user's operation can be ensured.

(8) In the configuration of any one of (4) to (7), the limiting may include limiting movement of at least one of the first and second objects in the first region based on the another user's input.

With the configuration of (8), in the virtual space, a region in which none of the first and second objects can be moved by the another user's operation can be ensured.

(9) In the configuration of any one of (1) to (8), further, a state of a virtual space that is the same as the virtual space including at least the plurality of first objects may be changed by performing at least one of arrangement, movement, and removal of at least one of the first and second objects at, to, and from a position in the virtual space specified based on another user's input. In the virtual space, a region having an extent in the horizontal direction set based on a height in the virtual space at which the second object associated with the another user is arranged based on the another user's input, and including a position related to the horizontal direction of the second object, may be set as a second region related to the another use. The limiting may include limiting changing of the state of the virtual space in the second region without the another user's input to change the state of the virtual space being performed.

With the configuration of (9), the second region having a function similar to that of the first region can be set in the same virtual space by arranging the second object in the same virtual space according to the another user's operation.

(10) In the configuration of (9), the setting the first region may include, when the first region to be set overlaps the second region already set, setting, as the first region, a region having a size reduced by excluding at least the overlap region.

With the configuration of (10), the first region can be set even when the first region overlaps the second region.

(11) In the configuration of any one of (1) to (10), the setting the first region may include, when the first region to be set overlaps the second region already set, setting the first region that does not overlap the second region, by causing the first region to have the same shape as that of a region set when the overlapping does not occur and to have an extent obtained by reducing an extent in the horizontal direction of the region.

With the configuration of (11), in the case in which the shape of the first region is changed due to overlapping of the first region with the second region, it is difficult to recognize the size of the first region. Compared to this, if the first region is set as a region having the same shape and a reduced size, the size of the first region can be easily recognized even when overlapping occurs.

(12) In the configuration of any one of (1) to (11), the virtual space may be a three-dimensional virtual space.

With the configuration of (12), even in a game using a three-dimensional virtual space, the first region can be set based on the user's input to arrange the second object, and therefore, the number of times the user performs an operation required for setting the region in the virtual space can be reduced.

(13) In the configuration of any one of (1) to (12), the first region may have an extent in the horizontal direction, the center of the extent being located at the position of the second object.

With the configuration of (13), the center in the horizontal direction of the first region can be easily recognized.

(14) In the configuration of (13), the first region may include a circle in the horizontal direction, the center of the circle being located at the position of the second object.

With the configuration of (14), every point on the boundary of the first region has an equal distance from the position of the second object on the same horizontal plane, and therefore, the range of the first region can be easily recognized.

(15) In the configuration of (14), the first region may be in the shape of a cylinder, the axis of the cylinder being a vertical straight line in the virtual space passing through the position of the second object.

With the configuration of (15), by setting the first region in the shape of a cylinder, the load of processing for determining whether or not the player character is located in the first region can be reduced, compared to the first region is in the shape of a polyhedron or the like.

(16) In the configuration of (14), the first region may be in the shape of a hemisphere-cylinder that is a combination of a cylinder, the axis of the cylinder being a vertical straight line in the virtual space passing through the position of the second object, and a hemisphere, the center of the hemisphere being located at the position of the second object and the pole of the hemisphere being located above the second object.

With the configuration of (16), the first region can be set so as to have different shapes above and below the second object, while an increase in the load of processing for determining whether or not the player character is located in the first region is reduced.

(17) In the configuration of any one of (1) to (16), the setting the first region may include, when the second object setting the first region is moved in the virtual space, setting the first region in the virtual space again based on the position after the movement.

In the configuration of (17), by moving the second object, the first region can be set at a position different from the position at which the first region has once been set.

(18) In the configuration of any one of (1) to (17), the setting the first region may include, when the second object setting the first region is moved in the virtual space, causing the first region to continue to be set during the movement, and when rearranging the second object in the virtual space after the end of the movement, removing the first region continuing to be set, and setting a new first region in the virtual space based on the position of the rearranged second object.

With the configuration of (18), during the time when the second object is moved until the second object is rearranged at another position, the first region that has been set before the movement is maintained, and therefore, during the movement, a limitation can also be imposed on changing of the state in the first region that has been set before the movement.

(19) In the configuration of any one of (4) to (11), the setting the first region may include causing the first region to continue to be set even during a period of time when the user who has set the second object temporarily pauses to play a game using the virtual space. The limiting may include limiting changing of the state of the virtual space in the first region based on the another user's input even during the period of time.

With the configuration of (19), a region in which the state of the virtual space is not changed by the another user's operation even when the user temporarily pauses to play a game, can be ensured.

In the configuration of (19), the setting the first region may include removing the setting of the first region from the virtual space when the user who has set the second object continues to pause even after a period of time has passed since the pause.

With the configuration of (20), the region in which changing of the state of the virtual space is limited can be prevented from remaining for a long period of time and obstructing other users' play.

In addition, the present example may be carried out in the forms of a storage medium, information processing apparatus, and information processing method.

According to the present example, a user's operation required for setting a region in a virtual space can be optimized.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a block diagram illustrating a non-limiting example configuration of an information processing system,

FIG. 9 is a block diagram illustrating a non-limiting example configuration of a server 102,

FIG. 10 is a diagram illustrating a non-limiting example of a game image showing a plurality of player characters PC arranged in the same game space,

FIG. 11 is a diagram illustrating a game image showing a non-limiting example of a first stage of a first player character PC1's action of arranging a first region setting object A1 in a game space,

FIG. 12 is a diagram illustrating a game image showing a second stage of a first player character PC1's action of arranging a first region setting object A1 in a game space,

FIG. 13 is a diagram illustrating a non-limiting example of a game image in a state in which a first player character PC1 is located in a first region R1,

FIG. 14 is a diagram illustrating a non-limiting example of a game image in which a second player character PC2 is located in a first region R1,

FIG. 15 is a diagram illustrating a non-limiting example of a region R1a in which a first region setting object A1 is arranged at a relatively low position in a game space,

FIG. 16 is a diagram illustrating a non-limiting example of a region R1b that is set when a first region setting object A1 is arranged at a relatively high position in a game space,

FIG. 17 is a diagram illustrating a first non-limiting example shape that is another non-limiting example of the shape of a first region R1,

FIG. 18 is a diagram showing a second non-limiting example shape that is another non-limiting example of the shape of a first region R1,

FIG. 19 is a diagram illustrating a non-limiting example of a state in which a second region R2 overlaps a first region R1 that has already been set,

FIG. 20 is a diagram illustrating a non-limiting example in which the overlapping state of FIG. 19 is removed, and a second region R2 is set,

FIG. 21 is a diagram illustrating another non-limiting example in which a second region R2 is set by removing the overlapping state of FIG. 19,

FIG. 22 is a diagram illustrating a non-limiting example in which a first region R1 is set in a two-dimensional side-scrolling game,

FIG. 23 is a diagram illustrating a non-limiting example of respective regions that are set when a third region R3 overlaps a first region R1 already set,

FIG. 24 is a diagram illustrating a non-limiting example of a data area set in a DRAM 85 of a main body apparatus 2,

FIG. 25 is a flowchart illustrating a non-limiting example of a game process that is executed in a game system 1,

FIG. 26 is a subroutine indicating a non-limiting example of a first stage of a player character control process in step S123 of FIG. 25,

FIG. 27 is a subroutine indicating a non-limiting example of a second stage of the player character control process in step S123 of FIG. 25, and

FIG. 28 is a subroutine indicating a non-limiting example of an other-player character control process in step S124 of FIG. 25.

### DETAILED DESCRIPTION OF NON-LIMITING EXAMPLE EMBODIMENTS

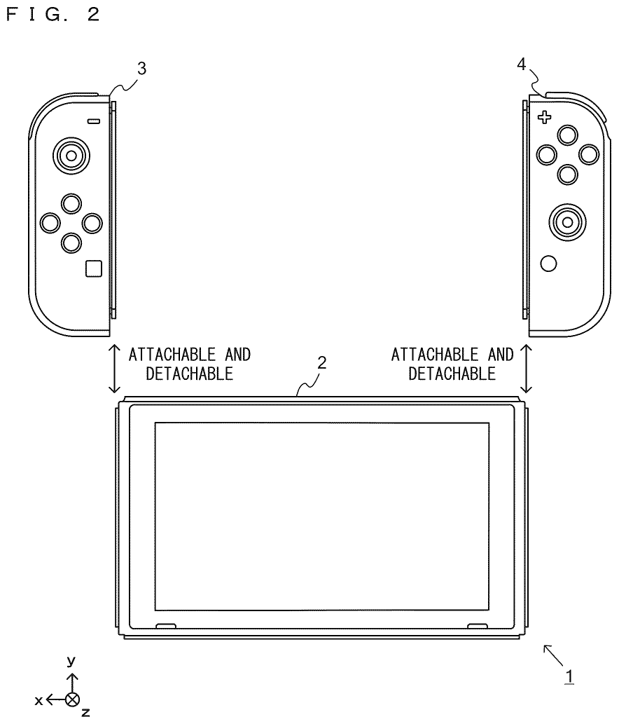

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

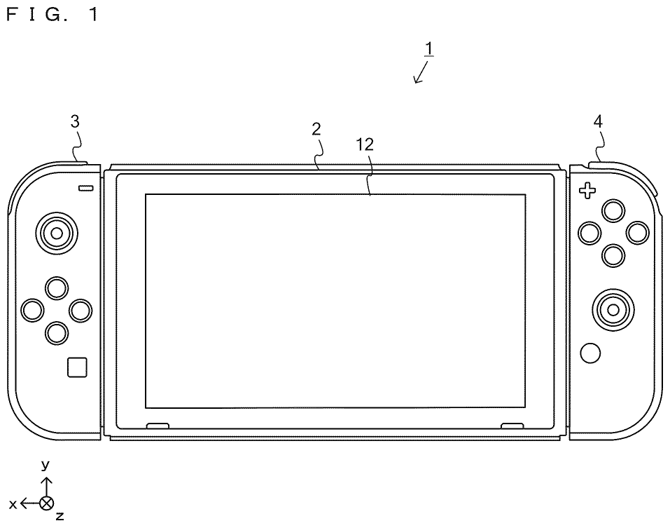

FIG. 1 is a diagram illustrating an example of a state in which the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating an example of a state in which each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

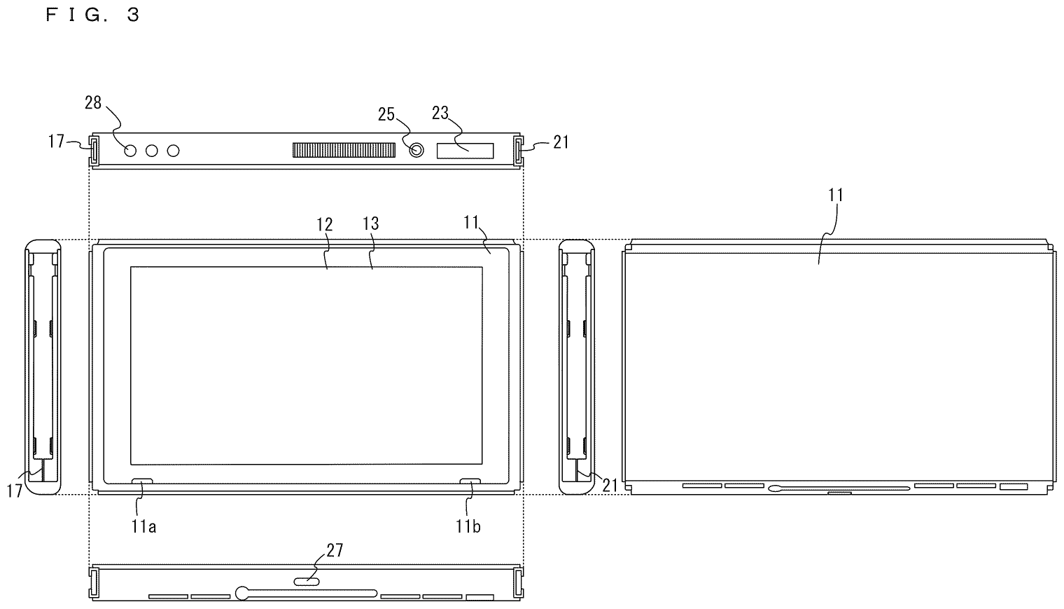

FIG. 3 illustrates six orthogonal views of an example of the main body apparatus 2. As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

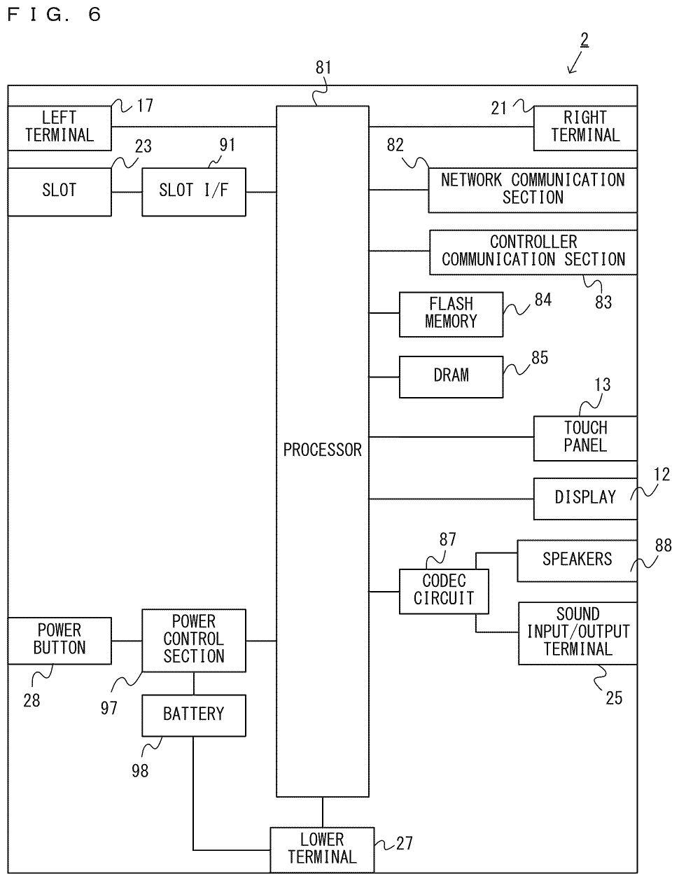

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system I can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

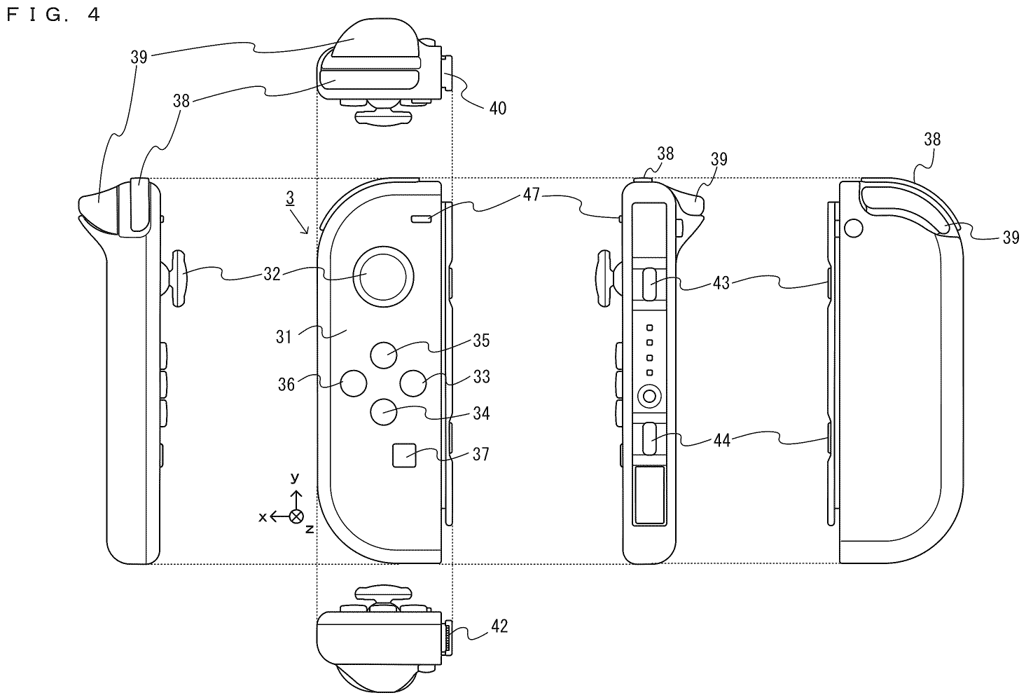

FIG. 4 illustrates six orthogonal views of an example of the left controller 3. As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

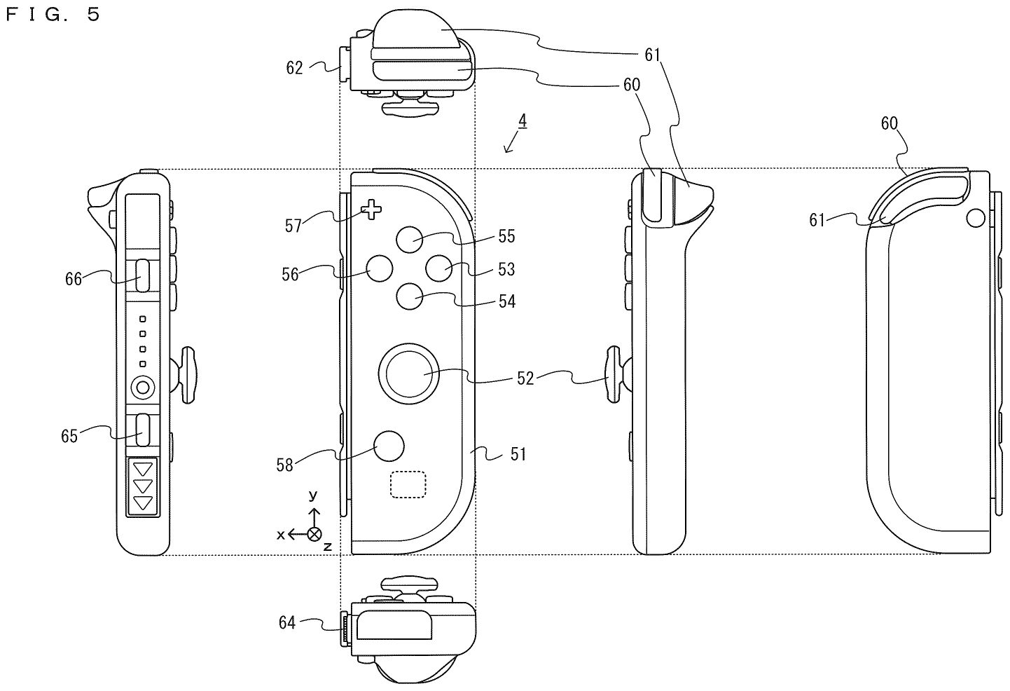

FIG. 5 illustrates six orthogonal views of an example of the right controller 4. As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52

as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating an example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to provisionally store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

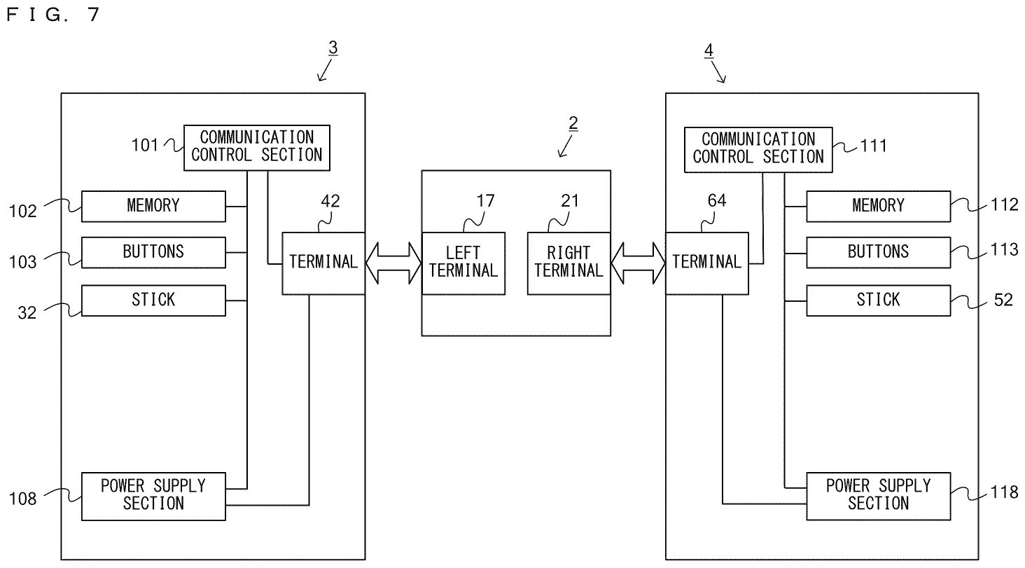

FIG. 7 is a block diagram illustrating examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a virtual space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs actions in the virtual space according to the user's operation performed using the operation buttons and sticks.

In the present example, a game in which a plurality of users are allowed to operate respective corresponding player characters so that the player characters perform actions in the same virtual space can be executed. The game is implemented by a plurality of users utilizing systems in a plurality of forms. As a first example, a game is implemented by a plurality of users operating respective player characters using respective game systems 1, and utilizing an information processing system (e.g., an information processing system in which a plurality of main body apparatuses 2 communicate with each other through a network) in which the network communication section 82 of each game system 1 performs communication through a network using the first communication form. As a second example, a game is implemented by a plurality of users operating respective player characters using respective game systems 1, and utilizing an information processing system (e.g., an information processing system in which a plurality of main body apparatuses 2 directly communicate with each other) in which the network communication section 82 of each game system 1 performs direct communication using the second communication form. As a third example, a game is implemented by inputting operation data produced by a plurality of users operating the left controller 3 and/or the right controller 4 into a single main body apparatus 2, and controlling each user's player character in the same virtual space using the single main body apparatus 2. In the present example, although, a system having any of the embodiments may be used, an example in which a game is implemented using an information processing system of the first example is used below.

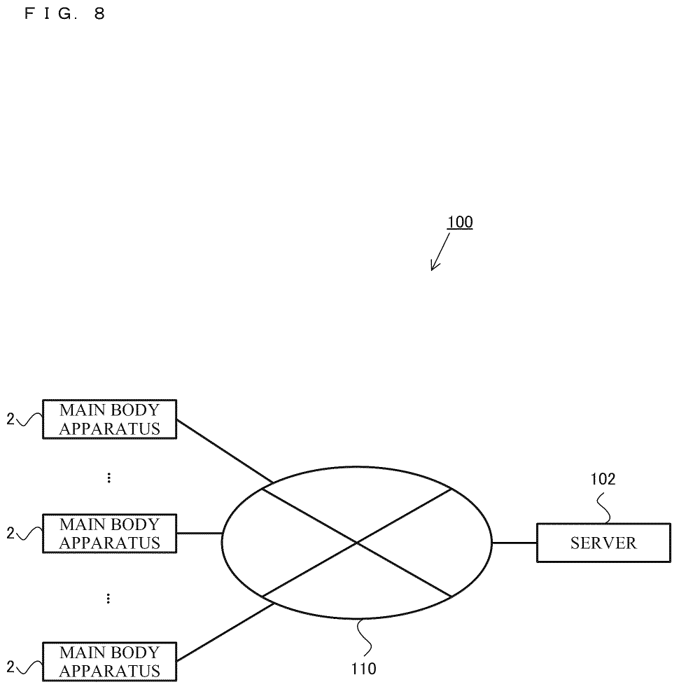

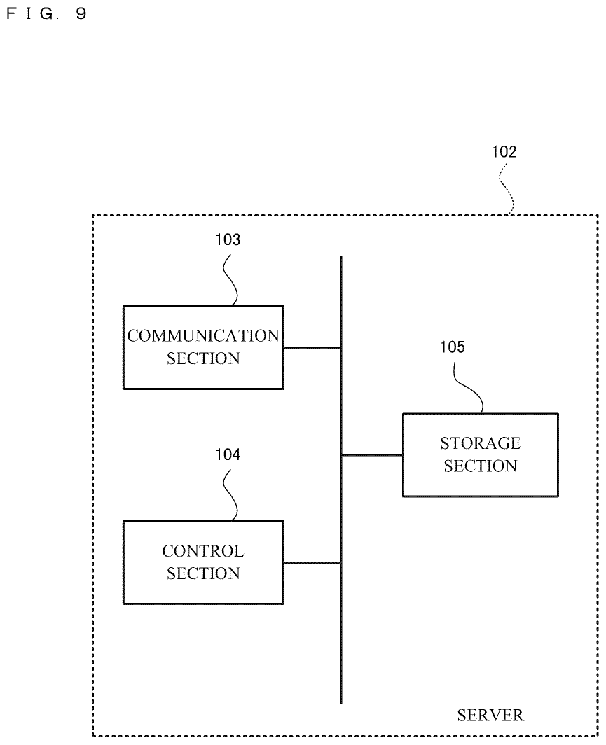

An information processing system of the first example that includes a plurality of game systems 1 and the server 102 will be described with reference to FIG. 8. FIG. 8 is a block diagram illustrating an example configuration of the information processing system. FIG. 9 is a block diagram illustrating an example configuration of the server 102.

As illustrated in FIG. 8, the plurality of game systems 1 (main body apparatuses 2) and the server 102 are connected together through a network 110 to form an information processing system 100. The game system 1 is configured to be able to connect to the network 110 by the above first communication form using wireless or wired communication, and together with the server 102, forms a client-server system. For example, the game system 1 can execute a predetermined application (e.g., a game application). In addition, by executing the predetermined application, the game system 1 can establish connection to the server 102 through the network 110 and communicate with the server 102 through the network 110.

The server 102 has a communication section 103, a control section 104, and a storage section 105. The communication section 103 communicates with the game systems 1 and the like through the network 110 by transmitting and receiving communication packets. As an example, the control section 104 performs a process of managing progression of a game played along with the game systems 1, a process of managing a game space used in a game, a process of managing each user's score, a process of managing information about payment or charging, and the like. The control section 104 also establishes a communication link to the game systems 1 and the like through the communication section 103, and performs data transmission control and routing on the network 110. In addition, when a game is played along with a plurality of game systems 1 (e.g., a game in which a plurality of users operate respective corresponding player characters so that the player characters perform actions in the same virtual space), the control section 104 manages pairing or grouping of game systems 1 that perform the game, and data communication between the game systems 1. The storage section 105 stores a program executed by the control section 104, various types of data required for the process, various types of data required for communication with the game systems 1, and the like. It should be noted that, in the case of a system in which a predetermined log-in process is required for data exchange performed through the network or joining a game, the server may execute an authentication process to determine whether or not a user who is trying to log in is an authorized user. In addition, the server may be a single server machine or may include a plurality of server machines.

In the present example, in the information processing system 100, the game systems 1 exchange operation information through the server 102, so that a networked game in which player characters corresponding to respective users perform actions in the same virtual space as a shared space is played. The operation information exchanged in the networked game may be information about player characters operated by the users using controllers, information about a game space edited by the player characters' actions, details of operations themselves performed by the users operating the player characters using controllers, or other information with which game progression in the game systems 1 can be understood.

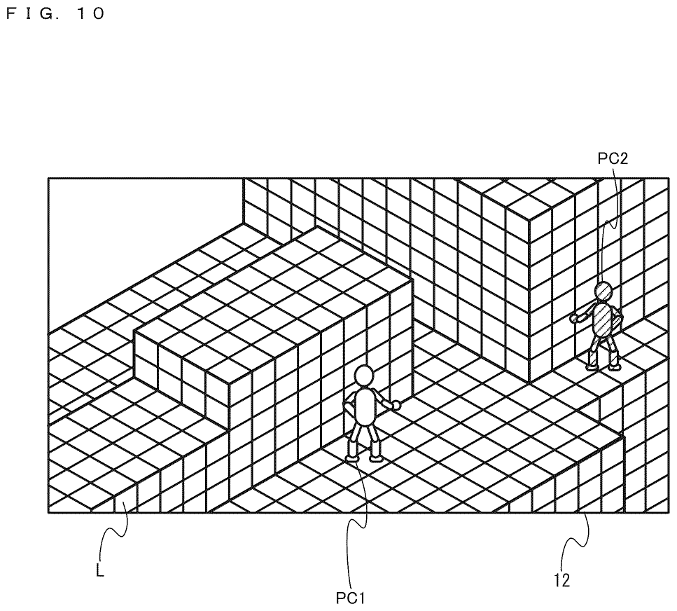

An example game process performed in the game systems 1 included in the information processing system 100 will be outlined with reference to FIGS. 10 to 22. Firstly, in the overview of the example game process, a game space used in the example game process will be outlined with reference to FIG. 10. It should be noted that FIG. 10 is a diagram illustrating an example of a game image showing a plurality of player characters PC arranged in the same game space.

In FIG. 10, the shape of a terrain such as a ground surface in a game space that is used in the example game process is specified using a plurality of objects L (a plurality of pieces). The plurality of objects L, which have a rectangular cuboid shape (more specifically, a cubic shape), are arranged in a grid pattern in a game space. As an example, in the present example, a parameter related to an object L is set at each of coordinate points set in a game space, and for each coordinate point, the game system 1 stores a parameter indicating whether or not an object L exists at that coordinate point. Thus, the game system 1 can specify a shape constituted by a plurality of objects L in a game space by managing whether or not an object L exists for each coordinate point in the game space (i.e., the parameter is stored for each coordinate point). It should be noted that objects L may have a rough surface, and may have rounded corners.

In another example, in the game system 1, a parameter may be set for each object L existing in a game space. The parameter set for each object L indicates at least the position of that object L in the game space. Thus, in the game system 1, the shape constituted by a plurality of objects L in a game space can be specified by managing the position of each object L in the game space (i.e., storing the parameter for each object L).

The shape of a terrain in a game space can be changed by removing or adding objects L on an object L-by-object L basis. In the present example, by rewriting the parameter such that a portion of a plurality of objects L constituting a terrain are removed, the states of the objects L can be changed, and therefore, the shape of the terrain can be easily changed. In addition, a terrain can also be added in a manner similar to when objects L are removed. Specifically, by rewriting the parameter such that objects L are arranged on an object L-by-object L basis, the states of the objects L can be changed, and therefore, the shape of a terrain can be easily changed. Thus, in the present example, by rewriting the parameter, the states of objects L can be changed, and therefore, the shape of a terrain in a game space can be easily changed and edited. As a first example, when some objects L are destroyed by a player character PC hitting a terrain or the like, the shape of the terrain may be changed. In this case, a game space can be edited such that the shape of the terrain is changed by removing a portion of the objects L. As a second example, when a player character PC moves a portion of a terrain or the like, the shape of the terrain may be changed. In this case, a game space can be edited such that the shape of the terrain is changed by removing a portion of the objects L. As a third example, when a player character PC adds a terrain or the like, the shape of the terrain may be changed. In this case, a game space can be edited such that the shape of the terrain is changed by newly arranging objects L. Thus, objects L serve as a terrain piece or terrain block with which the state of a terrain in a game space can be changed.

In addition, in the present example, a terrain in a game space may be constituted by a plurality of types of objects L having different properties or appearances. In that case, the parameter may include any data that can specify the properties or appearances of arranged objects L. For example, the parameter may include data that can specify properties such as materials (sands, rocks, soils, ices, and the like), fragility, and ability to join to other objects, data that can specify appearances such as texture used for objects L, and the like, so that the states of a plurality of types of objects L can be set.

In addition, an object L may be able to be joined to another adjacent object L to form an integrated object. For example, when a player character PC performs a predetermined action, a plurality of objects L that are a target for that action may be joined and integrated together. In this case, the parameter may include data that can specify whether or not objects L are joined and integrated together, or the like, so that it can be set whether or not an object L is joined and integrated with another object L. In the present example, changing the state of a game space and changing the state of an object L include changing in which an object L is joined and integrated with another object L and changing in which the integration is removed. As a first example, in the present example, an object L may be joined and integrated with another object L adjacent thereto, and therefore, these objects L can be moved by being lifted up with a positional relationship (arrangement) thereof maintained, for example. As a second example, in the present example, an object L may be joined and integrated with another object L adjacent thereto, and therefore, the orientation of these objects L can be changed by lifting up the objects L with a positional relationship (arrangement) thereof maintained. As a third example, an object L may be joined and integrated with another object L adjacent thereto, and therefore, even when no other object exists under at least one of these objects L, which is thus not supported from below, then if the other object L is supported from below, the object that is not supported from below may not fall, so that the positional relationship (arrangement) thereof can be maintained.

In addition, when an object L is removed from a game space by a player character PC destroying the object L, an item corresponding to the object L (e.g., a card item indicating a material for the object L) may be able to be caused to appear in the game space. In the present example, changing the state of a game space may include causing the item to appear in the game space when an object L is removed from the game space. In addition, an object L may be able to be produced from the item, and changing the state of a game space or changing the state of an object may include arranging an object L produced from the item in the game space.

In addition, other states of an object L may be able to be changed. For example, changing the state of an object L may include changing the shape or type of an object L itself arranged in a game space, changing or rotating the pose of an object L arranged in a game space, changing the durability value or properties (whether or not an object L can be moved, whether or not an object L can be joined, or the like) of an object L arranged in a game space, and the like. In the present example, these states may be specified by the parameter, and the state of an object L may be changed by rewriting the parameters.

In the present example, a game space constituted by a plurality of objects L is used to perform a game in which a plurality of users operates respective corresponding player characters PC so as to cause the player characters PC to perform actions. For example, in an example illustrated in FIG. 10, a first player character PC1 and a second player character PC2 are arranged on a terrain constituted by a plurality of objects L. The first player character PC1 corresponds to the user of a game system 1 (hereinafter referred to as a first user), and performs actions in the game space according to the first user's operation of the left controller 3 and/or the right controller 4 of the game system 1. The second player character PC2 corresponds to the user of another game system 1 (hereinafter referred to as a second user), and performs actions in the same game space as that in which the first player character PC1 is arranged, according to the second user's operation of the left controller 3 and/or the right controller 4 in the another game system 1.

A state in a game space can be changed and edited by a plurality of users operating and causing the respective player characters PC to perform an action to execute at least one of arrangement, movement, and removal of an object L in the game space. For example, by causing the first player character PC1 to perform an action based on the first user's operation input, the first user can move an object L to a position in the game space corresponding to the action, remove an object L from a position in the game space corresponding to the action, or newly arrange an object L at a position in the game space corresponding to the action. In addition, by causing the second player character PC2 to perform an action based on the second user's operation input, the second user can also, in the same game space, move an object L to a position in the game space corresponding to the action, remove an object L from a position in the game space corresponding to the action, or newly arrange an object L at a position in the game space corresponding to the action.

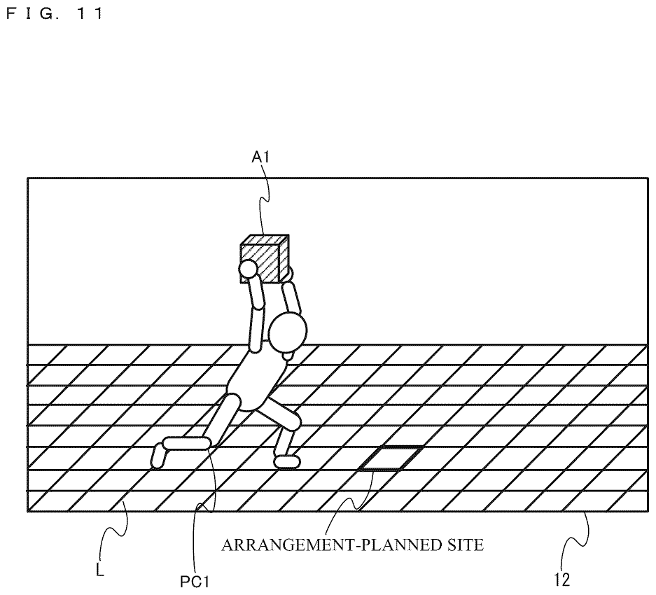

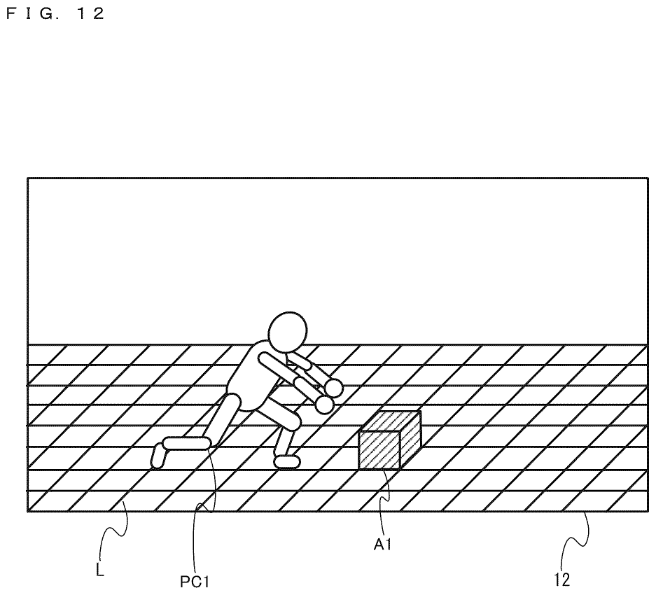

In addition, in the present example, a state in the game space can be changed and edited by executing at least one of arrangement, movement, and removal of a specific object different from objects L. An example in which the inside of a game space is changed using a region setting object that is an example of the specific object will be described below with reference to FIGS. 11 and 12. It should be noted that FIG. 11 is a diagram illustrating a game image showing an example of a first stage of the first player character PC1′s action of arranging a first region setting object A1 in a game space. FIG. 12 is a diagram illustrating a game image showing a second stage of the first player character PC1's action of arranging the first region setting object A1 in the game space.

In FIG. 11, the first player character PC1 is arranged on a ground surface (objects L) in the game space, holding the first region setting object Al with the hands thereof. The first region setting object A1 can be lifted up and moved, or stored by the first player character PC1 performing a predetermined acquisition action (e.g., an action of lifting up or storing the first region setting object A1 arranged in the game space). When the first player character PC1 moves in the game space while lifting up or storing the first region setting object A1, the first region setting object A1 is moved together with the first player character PC1. It should be noted that, by the first player character PC1's predetermined acquisition action, an object existing in front of the first player character PC1 or an object closest to the first player character PC1 may be designated as the first region setting object A1 that is a target for the action. Here, the state in which the first player character PC1 stores the first region setting object A1 refers to a state in which the first player character PC1 is allowed to carry the first region setting object A1 as an item or the like without holding or wearing the first region setting object A1, for example. At this time, the first region setting object A1 may not be displayed in the game space. The first region setting object A1 thus stored can be arranged or used (including wearing and holding) in the game space according to the first user's operation input, basically in appropriate situations. As an example, for example, the first player character PC1 may store the first region setting object A1 by putting the first region setting object A1 into a container such as a pouch or an item box. It should be noted that such a container may not be displayed. In addition, the container such as a pouch or an item box may not exit in the game space, and only a function of storing the first region setting object A1 may exist. In addition, by the first player character PC1 pushing the first region setting object A1 on the ground surface (objects L) in the game space, the first region setting object A1 may be moved together with the first player character PC1 in the game space in the direction in which the first region setting object A1 is pushed.

It should be noted that the first region setting object A1 may be previously arranged in a game space (on objects L) during the start of a game, or may be arranged at a predetermined position when a player level reaches a predetermined level or a predetermined acquisition condition is satisfied, e.g., a mission is achieved, or may be arranged when another character drops the first region setting object A1, or another character is beaten. The first region setting object A1 may be obtained from an object that is not a region setting object. In addition, a particular object may be changed to the first region setting object A1 when a particular motion is performed on the particular object.

In FIG. 12, the first player character PC1 performs an arrangement action of placing or throwing the first region setting object A1 carried by the first player character PC1 according to the first user's action instruction operation input. As a result, the first region setting object A1 is arranged at a position on objects L constituting a ground surface in a game space based on the arrangement action according to the user's operation input, with reference to the position of the first player character PC1. As an example, when the first player character PC1 performs an arrangement action of placing the first region setting object A1 carried by the first player character PC1, the first region setting object A1 is placed and arranged in contact with an object L that is located immediately before the first player character PC1. As another example, when the first player character PC1 performs an arrangement action of throwing the first region setting object A1 carried by the first player character PC1, the first region setting object A1 is thrown and arranged in contact with an object L that is located at a position that is a predetermined distance (corresponding to a predetermined number of objects L) away from the first player character PC1 in the front direction of the first player character PC1.

It should be noted that a position at which the first region setting object A1 is predicted to be arranged if the first player character PC1 performs the above arrangement action may be rendered on an object L. For example, as illustrated in FIG. 11, when the first player character PC1 performs the above arrangement action of arranging the first region setting object A1 carried by the first player character PC1 as illustrated in FIG. 11, an arrangement-planned site at which the first region setting object A1 is predicted to be arranged is rendered at a position that is a predetermined distance away from the first player character PC1 in the front direction thereof. Thus, if an arrangement-planned site at which the first region setting object A1 is to be arranged is displayed before the above arrangement action is performed, the user can know, in advance, the site at which the first region setting object A1 is to be arranged.

In addition, when an object L does not exist at a position where the first region setting object A1 is to be arranged, the first region setting object A1 may move and fall in the game space. In this case, the first region setting object A1 falling in the game space may hit another object after falling and moving by at least a predetermined distance to partially or completely destroy the another object, or may fall to the bottom of the game space and then disappear. In addition, even when an object L does not exist at a position where the first region setting object A1 is to be arranged, then if the first region setting object A1 comes into a positional relationship in which the first region setting object A1 is adjacent to an object L during falling in the game space, the first region setting object A1 may be arranged, adhering to the adjacent object L. In addition, as described below, by arranging the first region setting object A1 in the game space to set a first region R1, the effect of preventing the first region setting object A1 and an object L that are located in the first region from falling may be provided. For example, even if an object L that exists immediately below the first region setting object A1 or object L that is arranged in the first region R1 is removed by being destroyed or the like, the first region setting object A1 or object L that is arranged immediately above the removed object L may be maintained floating in the air without falling, and may fall if the effect of the first region R1 is removed.

In addition, in another example, the first region setting object A1 may be arranged at a position above an object L with reference to the position of the first player character PC1 without the first player character PC1 performing an arrangement action. In this case, the first region setting object A1 that is carried or stored by the first player character PC1 may be arranged at a position that is a predetermined distance away from the first player character PC1 in the front direction thereof according to the user's arrangement instruction operation input without the first player character PC1 performing a motion.

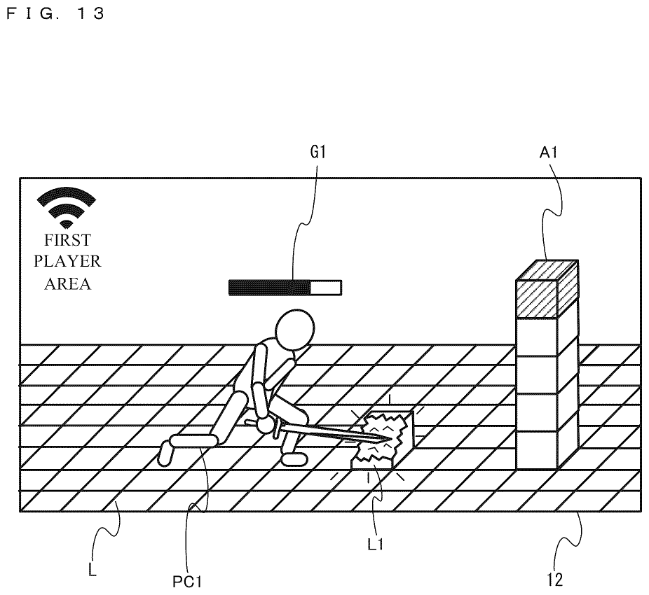

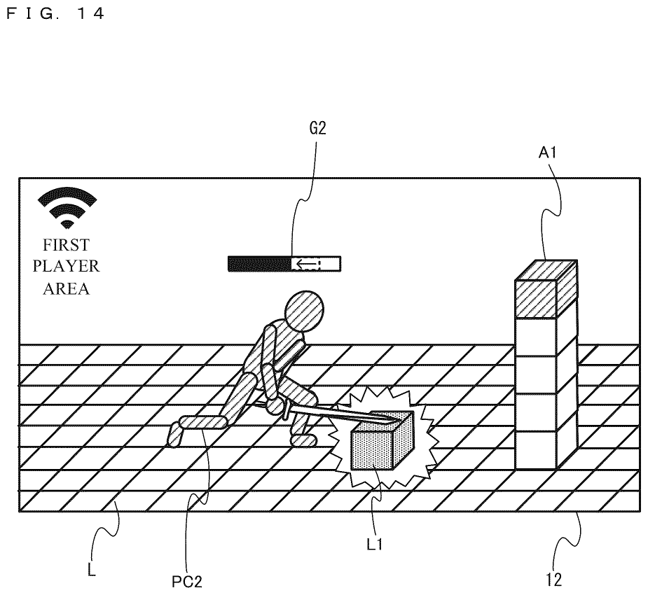

A function of the first region R1 set by arranging the first region setting object A1 in the game space will be described with reference to FIGS. 13 and 14. It should be noted that FIG. 13 is a diagram illustrating an example of a game image in a state in which the first player character PC1 is located in the first region R1. FIG. 14 is a diagram illustrating an example of a game image in which the second player character PC2 is located in the first region R1.

The first region setting object A1 is at least one object that is associated with the first player character PC1. The first region setting object A1 has the function of, when the first region setting object A1 is arranged in a game space, setting the first region R1 associated with the first player character PC1 in the game space. Here, the association with the first player character PC1 refers to a state in which only the first player character PC1, which is one of a plurality of player characters, is allowed to use, or an effect is only given to the first player character PC1. It should be noted that the first region R1 may be displayed in a display form that can distinguish the first region R1 from other regions in the game space. As a first example, a space in the first region R1 or a boundary of the first region R1 may be made distinguishable from other regions by being rendered in a color or lightness different from those of other regions. As a second example, objects L belonging to the first region R1 may be made distinguishable from other objects L by being rendered in a color or lightness different from those of other objects L. As a third example, a space in the first region R1 may be made distinguishable from other regions by being made lighter than the outside of the first region R1. For example, the visibility may be up to a predetermined distance outside the first region R1, while the visibility may be beyond the predetermined distance in the first region R1.

In the present example, the first player character PC1's action is controlled such that a predetermined action has a form that varies depending on whether or not the first player character PC1 is located in the first region R1. For example, when the first player character PC1 is located in the first region R1, a buffing effect is given to the first player character PC1. The first player character PC1's predetermined action is controlled so as to be more advantageous when the first player character PC1 has the given buffing effect than when the first player character PC1 does not have a buffing effect. Therefore, the first player character PC1 can perform the predetermined action more advantageously when the first player character PC1 is located in the first region RI than the first player character PC1 is not located in the first region R1. As a first example, when the first player character PC1 performs an action that is executed by reducing a parameter associated with the first player character PC1, a reduction in the parameter that occurs when the first player character PC1 performs the action in the first region R1 is smaller than a reduction in the parameter that occurs when the first player character PC1 performs the action outside the first region R1 (e.g., the former reduction in the parameter is zero, i.e., the parameter is not reduced). As a second example, when the first player character PC1 performs a movement action according to the first user's operation input, the movement speed that occurs when the first player character PC1 performs the action in the first region R1 is higher than the movement speed that occurs when the first player character PC1 performs the action outside the first region R1.

It should be noted that the buffing effect may be given to the first player character PC1 by any suitable action. For example, in the first example, an action with which the buffing effect is obtained may be highly beneficial to the first player character PC1, and may consume remaining energy as an example of the parameter due to the action. As an example, in the first example, an action with which the buffing effect is obtained may be the first player character PC1's action of changing the state of the game space, the first player character PC1's action of joining and integrating a plurality of objects L together in the game space, the first player character PC1's action of using a particular piece of equipment or tool, the first player character PC1's action of floating and moving in the air (e.g., hovering and moving), a particular action that is allowed when the first player character PC1 satisfies a particular condition, and the like. In addition, in the second example, an action with which the buffing effect is obtained may be the first player character PC1's movement action of walking, running, jumping, floating and moving in the air (e.g., hovering and moving), or the like, or the first player character PC1's action of riding on another object. In addition, in the second example, an action with which the buffing effect is obtained may be another object's movement action triggered by the first player character PC1's motion. For example, the movement speed of another object released from the first player character PC1 by being thrown or fired by the first player character PC1 may be increased by the buffing effect. In addition, as another example, in the second example, an action with which the buffing effect is obtained may be another action of improving the first player character PC1's ability due to the buffing effect. For example, the buffing effect may improve the first player character PC1's offensive power, defensive power, endurance, jumping power, search power, size, life, or the like, or the number of other objects released or the amount of another object released from the first player character PC1 may be increased by the buffing effect.

In addition, in the present example, changing the state of the game space is limited in the first region R1, except for changing of the state of the game space that is performed by the first player character PC1. For example, as described above, each player character PC is allowed to change and edit the state of the game space by executing at least one of arrangement, movement, and removal of an object L. However, in the first region R1, changing of the state of the game space that is performed by characters (including other player characters PC, such as the second player character PC2) other than the first player character PC1, for which the first region R1 is set, is limited, and the right to edit the game space is given to the first player character PC1. As a first example, in the first region R1, an editing right with which characters other than the first player character PC1 are forbidden to newly arrange an object (various types of objects including particular objects such as objects L and region setting objects) is given. As a second example, an editing right with which characters other than the first player character PC1 are forbidden to remove objects L or the first region setting object A1 from the first region RI is given. It should be noted that, in the present example, even the case in which an item related to an object L appears due to removal of the object L caused by destruction or the like, may be included in changing a game space due to removal of an object L. As a third example, an editing right with which characters other than the first player character PC1 are forbidden to move an object L or the first region setting object A1 in the first region R1 is given. It should be noted that, in the present example, the case in which an object L is lifted up from the position where the object L is arranged by the player character PC's action of lifting up the object L may be included in changing the state of a game space due to movement of an object L.

In addition, changing the state of a game space to impose a limitation includes changing the state of an object L by arranging, moving, and removing the object L, and may also include other changing. As an example, changing the state of a game space to impose a limitation may include changing the state of an object L by joining and integrating the object L with another object L in a game space, changing the state of an object L by removing integration of the object L with another object L in a game space, and the like. As another example, changing the state of a game space to impose a limitation may include changing the shape or type of an object L itself arranged in a game space, changing the pose of an object L arranged in a game space or rotating an object L arranged in a game space, changing the durability or properties (whether or not an object L can be moved, whether or not an object L can be joined, or the like) of an object L arranged in game space, and the like.

Thus, by giving an editing right related to the game space in the first region R1 to the first player character PC1, a limitation is imposed on other users' changing the state of the space in the first region R1 when the first region setting object A1 is arranged or the state of the game space in the first region R1 after having been most recently changed according to the first user's operation input. Here, the limitation on changing the state of a game space is not limited to a limitation on changing based on other users' operations, and may include a limitation on changing performed by characters (e.g., non-player characters) automatically controlled by a computer, and changing caused by phenomena other than characters' actions in a game space (collapse due to weather or shaking, and the like).

For example, in the example illustrated in FIG. 13, the first player character PC1 is arranged in a “first player area” in the first region R1 in which the first region setting object A1 is provided. In the first region R1, the first player character PC1 is performing an action of destroying and removing an object L1. Since the right to edit a game space has been given to the first player character PC1 in the first region R1, the first player character PC1 can destroy and remove the object L1 by performing the above action. In addition, as an example, remaining energy that is a parameter associated with the first player character PC1 and is indicated by a gage G1 in FIG. 13 is reduced by the above action outside the first region R1, and a buffing effect of avoiding such a reduction due to the above action is given to the first player character PC1 in the first region R1. As another example, a buffing effect that is given to the first player character PC1 in the first region R1 allows the first player character PC1 to move at a speed higher than that in the normal state when moving in the first region R1. It should be noted that the buffing effect may be given to the first player character PC1 when the first player character PC1 is entirely located in the first region R1, or when the first player character PC1 is at least partially located in the first region R1.

Meanwhile, in the state illustrated in FIG. 14, the second player character PC2 is arranged in the “first player area” for the first player character PC1 in the first region R1 in which the first region setting object A1 is provided. In the first region R1, the second player character PC2 is performing an action of destroying and removing the object L1. In such a game space in the first region R1, the second player character PC2 does not have an editing right, and therefore, cannot destroy or remove the object L1 even if the second player character PC2 performs the above action. In addition, since the buffing effect is not given to the second player character PC2 in the first region R1, remaining energy that is a parameter associated with the second player character PC2 and is indicated by a gage G2 in FIG. 14 is reduced by a predetermined amount due to the above action. In addition, since the buffing effect is not given to the second player character PC2 in the first region R1, the second player character PC2 moves at a normal movement speed when moving in the first region R1. It should be noted that the editing right may be given to an object (an object L or a particular object) when the object is either completely or at least partially included in the first region R1.

In the present example, in the case in which changing the state of a game space is limited, the limitation may be carried out by any suitable technique. As a first example, as described above, when the state of at least one object L is changed by the player character PC performing an action of changing the state of a game space, a limitation may be imposed so as to forbid a player character PC (e.g., the second player character PC2) to which an editing right has not been given to perform the changing action in the first region R1. Specifically, a player character PC is forbidden to perform an action of attacking and destroying an object L, an action of lifting up and moving an object L, an action of placing and arranging an object L, an action of throwing and arranging an object L, an action of joining and integrating objects L together, and the like, if an editing right has not been given to the player character PC in the first region R1. As a second example, as described above, in the case in which a parameter related to an object L is set for each coordinate point in a game space, and the state of an object L is managed for each coordinate point, even when a player character PC (e.g., the second player character PC2) to which an editing right has not been given in the first region R1 performs an action of performing an action for changing, a limitation may be imposed such that the parameter cannot be changed at any coordinate point in the first region R1. As a third example, as described above, in the case in which a parameter is set for each object Lin a game space, and the state of each object Lis managed, even when a player character PC (e.g., the second player character PC2) to which an editing right has not been given in the first region R1 performs an action for performing an action for changing, a limitation may be imposed such that the parameter of any object L in the first region R1 cannot be changed. As a fourth example, when an action of moving a single object into the first region R1 from the outside is performed, a limitation may be imposed on changing of the state by displaying a scene that the movement is repelled at a boundary of the first region R1 so that the object does not enter the first region R1. As an example, when a player character PC (e.g., the second player character PC2) to which an editing right has not been given in the first region R1 performs an action of throwing a single object into the first region R1 from the outside, the single object thus thrown may be repelled at a boundary of the first region R1 to fall and be arranged outside the first region R1.

In addition, in the present example, in the first region R1, changing the state of a game space performed by characters other than the first player character PC1, for which the first region R1 has been provided, is limited, and the right to edit the game space is given to the first player character PC1. Here, in the present example, the first region RI is set so as to include a site at which the second player character PC2 has changed the state of the game space, a limitation is imposed on changing of the state of the site that is performed by the second player character PC2 or changing of the state of the site that is performed by characters other than the first player character PC1 and the second player character PC2. Specifically, in the present example, even for a party that has changed the state of an object L (a creator that has created the object L, or an editor that has changed the object L; in this case, the second player character PC2), the first region R1 can be set such that a limitation is imposed on changing of an object L at the site that is performed by the party or changing of an object L at the site that is performed by characters other than the first player character PC1 and the second player character PC2. In addition, for an object L that has been changed by the party, if a limitation is always imposed on changing of the state of the object that is performed by characters other than the party, places in a game space that a player character PC is allowed to change are reduced as a game proceeds. In the present example, such a problem can be avoided by setting a region to which an editing right associated with a player character PC is given as described above.

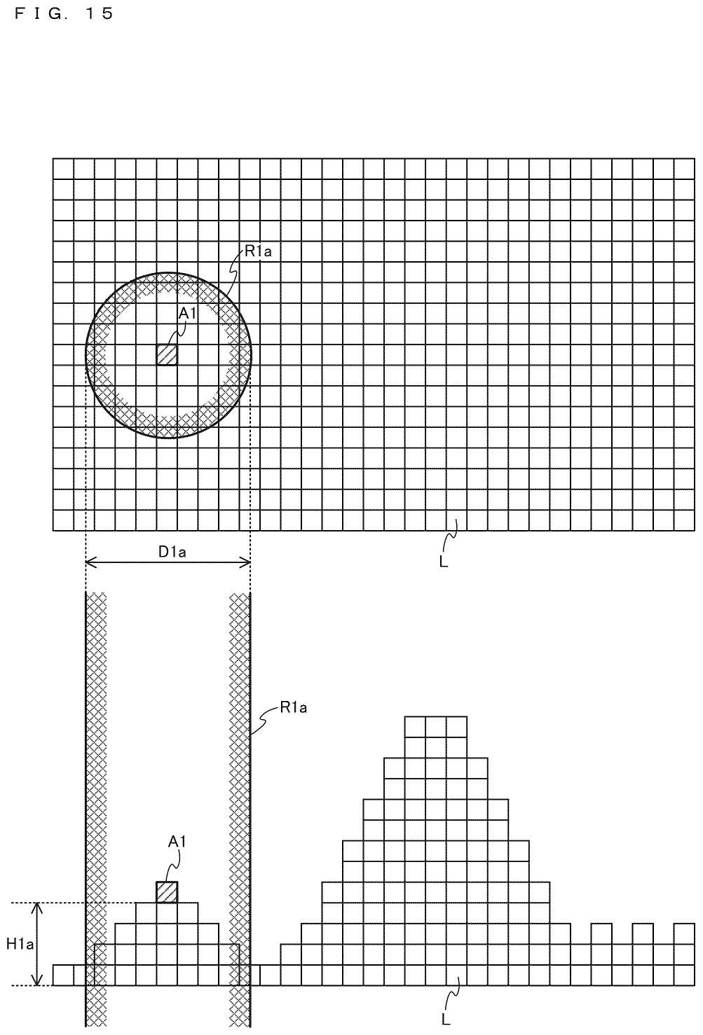

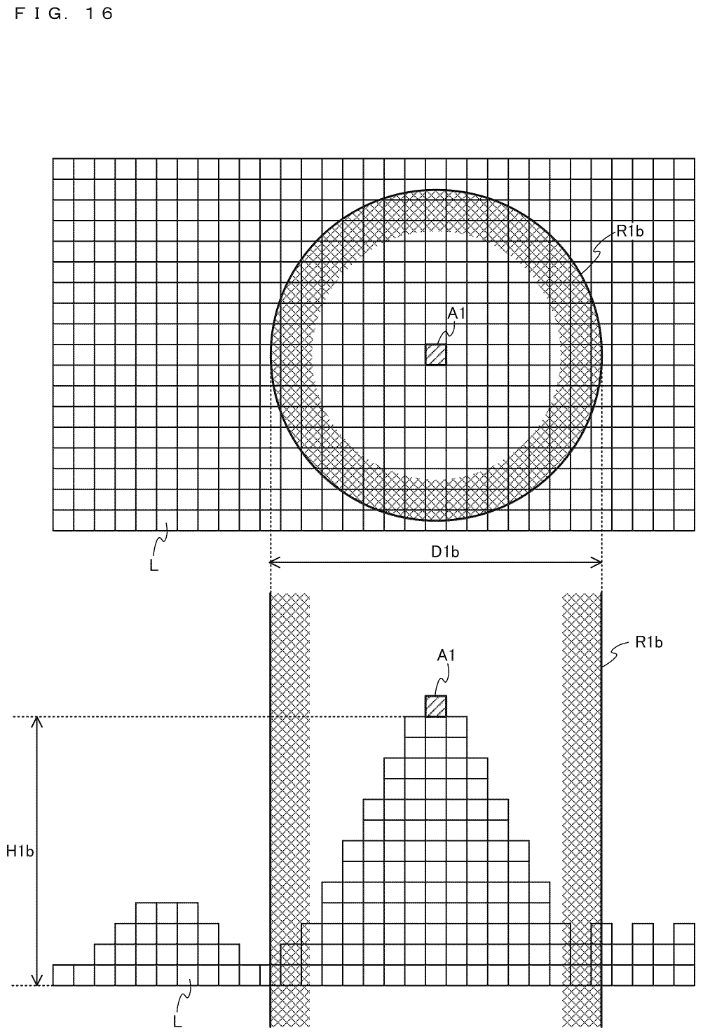

Next, an example of the position, shape, and size of a first region R1 that is set by arranging a first region setting object A1 in a game space will be described with reference to FIGS. 15 and 16. It should be noted that FIG. 15 is a diagram illustrating an example of a region R1a in which a first region setting object A1 is arranged at a relatively low position in a game space. In FIG. 15, the upper diagram is a top view of the first region setting object A1 and the first region R1a in the game space as viewed from above, and the lower diagram is a side view of the first region setting object A1 and the first region R1a in the game space as viewed laterally. FIG. 16 is a diagram illustrating an example of a region R1b that is set when a first region setting object A1 is arranged at a relatively high position in a game space. In FIG. 16, the upper diagram is a top view of the first region setting object A1 and the first region R1b in the game space as viewed from above, and the lower diagram is a side view of the first region setting object A1 and the first region R1b in the game space as viewed laterally.

As illustrated in FIG. 15, the first region R1a is set as a region including a position related to the horizontal direction of the first region setting object A1, and in the case in which a three-dimensional game space is set, is also set so as to include at least a portion of the first region setting object A1 arranged in the game space as viewed from above in the game space. Here, that at least a portion of the first region setting object A1 arranged in the game space is included as viewed from above in the game space means that at least a space in the game space in which the first region setting object A1 is located, a space in the game space immediately above the first region setting object A1, and/or a space in the game space immediately below the first region setting object A1 are included in a region (the first region R1a). As an example, the first region R1a is formed by a cylindrical space that extends up to a limit height in the vertical direction, and the axis of which is a vertical straight line passing through the position of the first region setting object A1 in the game space. In this case, the first region R1a has a circular horizontal shape, and the first region setting object A1 is arranged at the center of the circular shape and is thus included in the first region R1a. Here, the position of the first region setting object A1 may be a point that is used as a reference with which the first region setting object A1 is arranged in the game space, and that indicates the center of a lower surface of the first region setting object A1, the barycenter of the first region setting object A1, the center of an upper surface of the first region setting object A1, or the like. Thus, if the horizontal shape of the first region R1a is a circular shape the center of which is the first region setting object A1, every point on the boundary of the first region R1a has an equal distance from the position of the first region setting object A1 on the same horizontal plane. In addition, if the first region R1a has a cylindrical shape, the load of processing for determining whether or not a point is included in the region can be reduced compared to polyhedrons.

An extent in the horizontal direction of the first region R1a is set based on a height H1a in the game space in which the first region setting object A1 is arranged. As an example, in the case in which an x-coordinate, y-coordinate, and z-coordinate are defined in the horizontal direction, vertical direction, and depth direction, respectively, in the game space, the “extent in the horizontal direction” is the area of the first region R1a spreading in the xz plane in the game space, and the “height in the game space” is the y-coordinate of the position of the first region setting object A1. For example, the first region R1a has an extent in the horizontal direction, the center of the extent being located at the position of the first region setting object A1. In the case in which the first region R1a is formed in the above cylindrical space, a radius (diameter D1a) is set, the center of the cylindrical space being located at the position of the first region setting object A1, based on the height H1a in the game space at which the first region setting object A1 is arranged.

FIG. 16 illustrates a first region R1b that is set when the first region setting object A1 is arranged at a height H1b higher than the height H1a in the game space. As illustrated in FIG. 16, the first region R1b is also set so as to include at least a portion of the first region setting object A1 arranged in the game space as viewed from above in the game space. As an example, the first region R1b is also formed by a cylindrical space that extends up to a limit height in the vertical direction, and the axis of which is a vertical straight line passing through the position of the first region setting object A1. In this case, the first region R1b has a circular horizontal shape, and the first region setting object A1 is arranged at the center of the circular shape and is thus included in the first region R1b.

As with the first region R1a, the first region R1b has an extent in the horizontal direction, the center of the extent being located at the position of the first region setting object A1. In the case in which the first region R1b is formed by the above cylindrical space, a radius (diameter D1b) is set, the center of the cylindrical space being located at the position of the first region setting object A1, based on the height H1b in the game space at which the first region setting object A1 is arranged. Here, as can be seen from FIGS. 15 and 16, the extent in the horizontal direction of the first region R1b is greater than the extent in the horizontal direction of the first region R1a, and the radius (diameter) of the first region R1b, the center of which is located at the position of the first region setting object A1, is longer than that of the first region R1a (D1b>D1a). For example, the extent in the horizontal direction of the first region R1 is set so as to increase as the first region setting object A1 is arranged at a higher position. As an example, the extent in the horizontal direction of the first region R1 is set so as to be proportional to the height H1 at which the first region setting object A1 is arranged. In the case in which the extent is less than a predetermined value, the extent is set to the predetermined value. It should be noted that the height H1 may be an elevation or a height above the sea level in a game space, or a height above a predetermined reference position in a game space.

Therefore, the first user can set the first region R1, in which the above buffing effect and editing right are obtained, such that the extent of the first region R1 increases as the first region setting object A1 is arranged at a higher position, and therefore, can advantageously play a game. In addition, when the first region setting object A1 for setting the first region R1 is arranged in the game space, the first region setting object A1 is provided in the first region R1. In this case, by giving the above editing right, the first region setting object A1 provided in the first region R1 cannot be moved or removed by characters other than the first player character PC1, and therefore, serves as an object that is associated with the first player character PC1 and is only used by the first player character PC1.

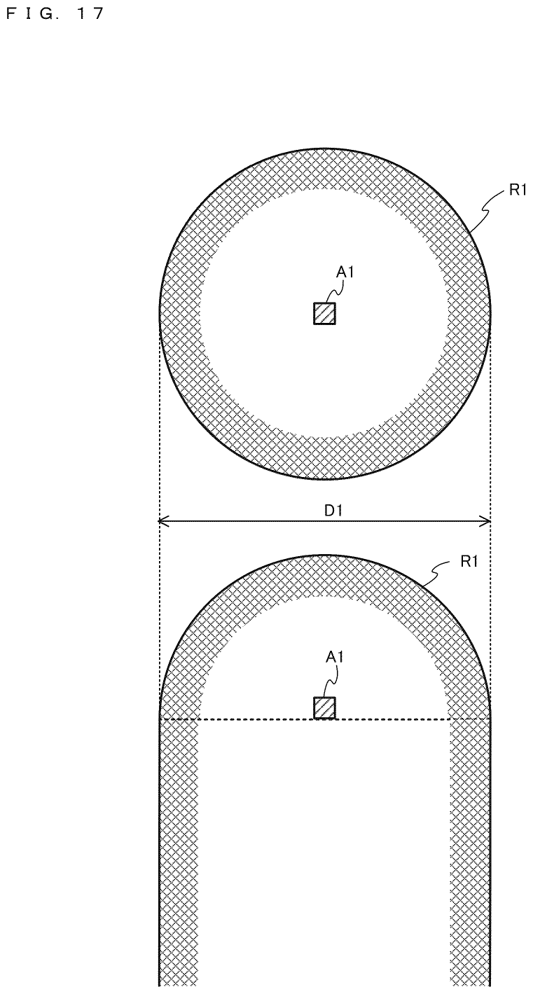

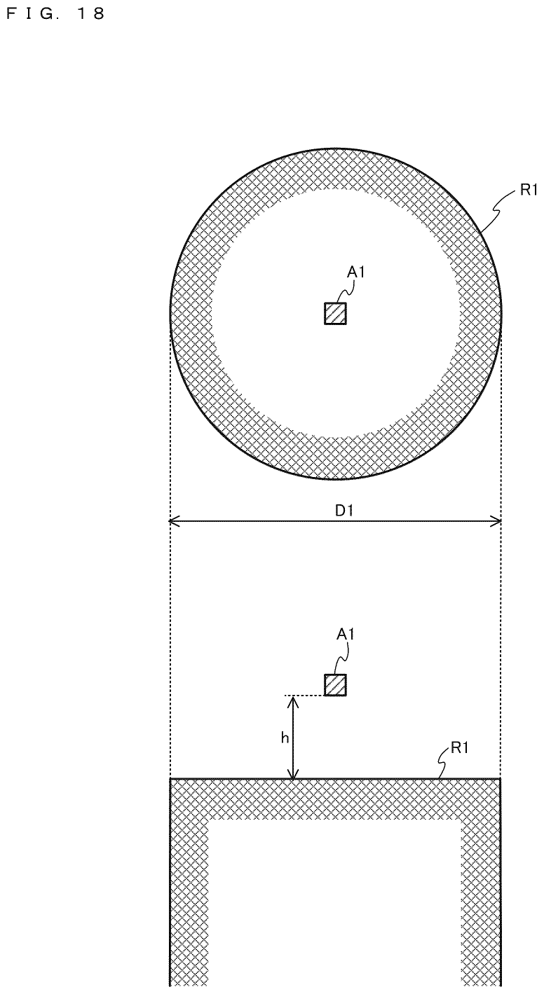

It should be noted that the shape of the first region R1 may be different from a cylindrical shape extending up to a vertical limit height in a game space. For example, FIG. 17 is a diagram illustrating a first example shape that is another example of the shape of the first region R1. In FIG. 17, the upper diagram is a top view of the first example shape of the first region R1 in a game space as viewed from above, and the lower diagram is a side view of the first example shape of the first region R1 in the game space as viewed laterally. FIG. 18 is a diagram showing a second example shape that is another example of the shape of the first region R1. In FIG. 18, the upper diagram is a top view of the second example shape of the first region R1 in a game space as viewed from above, and the lower diagram is a side view of the second example shape of the first region R1 in the game space as viewed laterally.

As illustrated in FIG. 17, the first example shape of the first region R1 is a hemispherical-cylindrical shape that is a combination of a cylinder the axis of which is a vertical straight line in a game space that passes through the position of the first region setting object A1, and a hemisphere the center of which is located at the position of the first region setting object A1 and the pole of which is located above the first region setting object A1. Specifically, in the first example shape of the first region R1, a surface at which the cylinder and the hemisphere are combined and joined (surface indicated by a dashed line in FIG. 17) is a horizontal plane passing through the position of the first region setting object A1 (e.g., the center of the lower surface of the first region setting object A1). The first region setting object A1 is provided in the first region R1 in the vicinity of the center of the horizontal plane. Even in the case of the first region R1 having such a first example shape, the radius (diameter D1) of the circle on the horizontal plane is set to be longer such that the extent in the horizontal direction of the first region R1 increases, as the first region setting object A1 is located at a higher position in the game space.

As illustrated in FIG. 18, the second example shape of the first region R1 is set to a cylindrical shape the axis of which is a vertical straight line in the game space that passes through the position of the first region setting object A1, and that extends up to a limit height in the downward direction in the game space from a position below the first region setting object A1. Specifically, the upper surface of the cylindrical shape that is the second example shape of the first region R1 is a horizontal plane that is located a distance h below the position of the first region setting object A1 (e.g., the center of the lower surface of the first region setting object A1). In the case of the first region R1 having such a second example shape, the first region R1 is set with the first region setting object A1 arranged in the game space being located in the vicinity of the center as viewed from above in the game space. However, the first region setting object A1 is provided outside the first region R1 the distance h above the upper surface of the first region R1. Even in the case of the first region R1 having such a second example shape, the radius (diameter D1) of the cylindrical shape is set to be longer such that the extent in the horizontal direction of the first region R1 increases, as the first region setting object A1 is located at a higher position in the game space.

It should be noted that the distance h may have a fixed value including zero, or may vary depending on the height in the game space at which the first region setting object A1 is arranged. In addition, in the second example shape of the first region R1, the first region setting object A1 is provided outside the first region R1, and therefore, can be moved and removed by other characters in addition to the first player character PC1. However, in order to prevent the first region setting object A1 from being changed by other characters, the first region setting object A1 may be set as an object that cannot be moved or removed by characters other than the first player character PC1 no matter where the first region setting object A1 is arranged.

In addition, the first region R1 may have any shape that includes a horizontal plane the center of which is located at the position of the first region setting object A1, a position immediately above the position of the first region setting object A1, or a position immediately below the position of the first region setting object A1. The shape of the first region R1 may be spherical, hemispherical, conical, elliptic-cylindrical, prismatic, regular polyhedral, semiregular polyhedral, rectangular cuboidal, pyramidal, or the like, or may be three-dimensional shapes such as other polyhedrons. In those cases, the first region setting object A1 for which the first region R1 is set may be arranged in the first region R1 (e.g., at the center of the first region R1 as viewed from above in the game space), or a boundary of the first region R1 (e.g., the center of an upper or lower surface of a three-dimensional shape or an apex of a three-dimensional shape), or may be arranged outside the first region R1. Thus, the position of the center of the first region R1 can be easily recognized by setting the shape of the first region R1 to a shape that includes a horizontal plane the center of which is located at a position based on the position of the first region setting object A1.

In addition, the first region R1 may have a planar shape. For example, the shape of the first region R1 may be circular, elliptic, circular sectorial, polygonal, or the like, and extends in the horizontal direction in the game space. In addition, the first region R1 having such a planar shape may be set around the position of the first region setting object A1 as the center thereof, or at a position immediately above or below the first region setting object A1.

In addition, in the present example, the extent in the horizontal direction of the first region R1 is set so as to increase as the first region setting object A1 is arranged at a higher position in the game space. A limitation may be imposed on the increased extent, and the extent may be increased in a stepwise manner. For example, when the height in the game space at which the first region setting object A1 is arranged reaches a predetermined height (e.g., 1000 m), a limitation may be imposed such that the extent in the horizontal direction of the first region R1 does not exceed the extent set at the predetermined height even if the first region setting object A1 is arranged at a height exceeding the predetermined height. In addition, the extent in the horizontal direction of the first region R1 that increases as the first region setting object A1 is arranged at a higher position in the game space may increase gradually and continuously, or in a stepwise manner, where each step is a predetermined height (e.g., the predetermined height is 5 m).

In addition, in the game space, when the first region setting object A1 moves, the first region R1 may move in association with the movement of the first region setting object A1. As a first example, when the first region setting object A1 that is arranged at a first position and for which the first region R1 is set moves to and is arranged at a second position, the first region R1 that has been set since the first region setting object A1 was arranged at the first position may be maintained during the movement until the first region setting object A1 is arranged at the second position. In that case, at the time when the first region setting object A1 is arranged at the second position, the first region R1 in which the first region setting object A1 was arranged at the first position is removed, and the first region R1 is newly set based on the first region setting object A1 arranged at the second position. As a second example, when the first region setting object A1 moves from a first position and is then arranged at a second position, the first region R1 that has been set since the first region setting object A1 was arranged at the first position may be removed at the time when the movement is started. In that case, the first region R1 is not set during the movement of the first region setting object A1, and is newly set at the time when the first region setting object A1 is arranged at the second position. As a third example, when the first region setting object A1 moves from a first position and is then arranged at a second position, another first region R1 may be set based on the first region setting object A1 that is arranged at the second position while the first region R1 in which the first region setting object A1 has been arranged at the first position continues to be set even after the first region setting object A1 is arranged at the second position. In that case, a plurality of first regions R1 may be set after the first region setting object A1 is arranged at the second position, and therefore, the first region R1 that has once been set is not removed due to the movement of the first region setting object A1.

Thus, according to the first to third examples, by rearranging the first region setting object A1 at another position, a first region R17 can be set at a position different from the position at which the first region R1 has once been set. In addition, according to the first and third examples, even during the movement of the first region setting object A1 to another position, the first region R1 that has been set before the movement is maintained, and therefore, the game space in the first region R1 can be prevented from being changed by other player characters PC during the movement. In addition, according to the first and third example, the first region setting object A1 can be rearranged while the first player character PC1 utilizes a buffing effect that has been set in the first region R1 before the movement.

In the present example, in the game space, another player character operated by another user can arrange a region setting object associated with the another player character. Other player characters are each associated with at least one region setting object. Other characters have a function of, when the region setting object is arranged in the game space, setting a region in the game space with reference to the position of the region setting object. For example, a second region setting object A2 that is associated with a second player character PC2 operated by a second user can be moved or stored by the second player character PC2 performing a predetermined acquisition action (e.g., an action of moving or storing the second region setting object A2 arranged in the game space). The second player character PC2 can handle the second region setting object A2 in a manner similar to that in which the first player character PC1 handles the first region setting object A1 associated with the first player character PC1.

The second region setting object A2 that is arranged in the game space by the second player character PC2 is associated with the second player character PC2 (i.e., an object that can only be used by the second player character PC2, of a plurality of player characters). The second region setting object A2 has a function of setting a second region R2 associated with the second player character PC2 in the game space when the second region setting object A2 is arranged in the game space. The second region R2 also has a function of giving the above buffing effect and editing right to the second player character PC2. For example, in the second region R2, when the first player character PC1 performs an action of changing the game space, the first player character PC1, which does not have an editing right, cannot change the object L1 even when the first player character PC1 performs the action. In addition, in the second region R2, a buffing effect is not given to the first player character PC1, and therefore, a parameter associated with the first player character PC1 is reduced by a predetermined amount due to the above action. In addition, in the second region R2, a buffing effect is not given to the first player character PC1, and therefore, the first player character PC1 moves at a normal speed when moving in the second region R2.

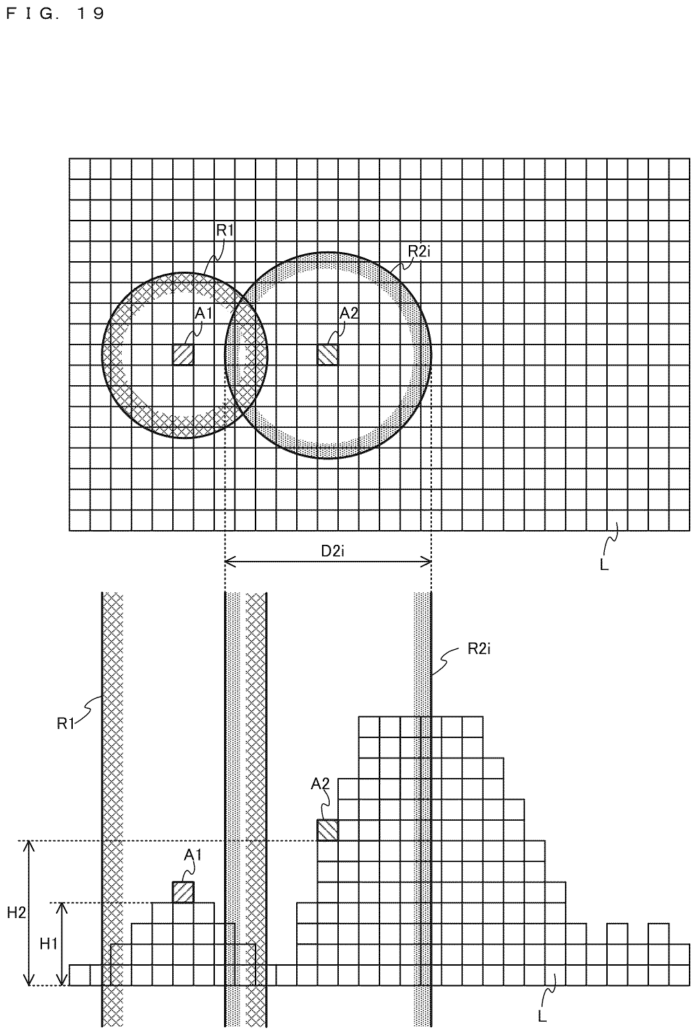

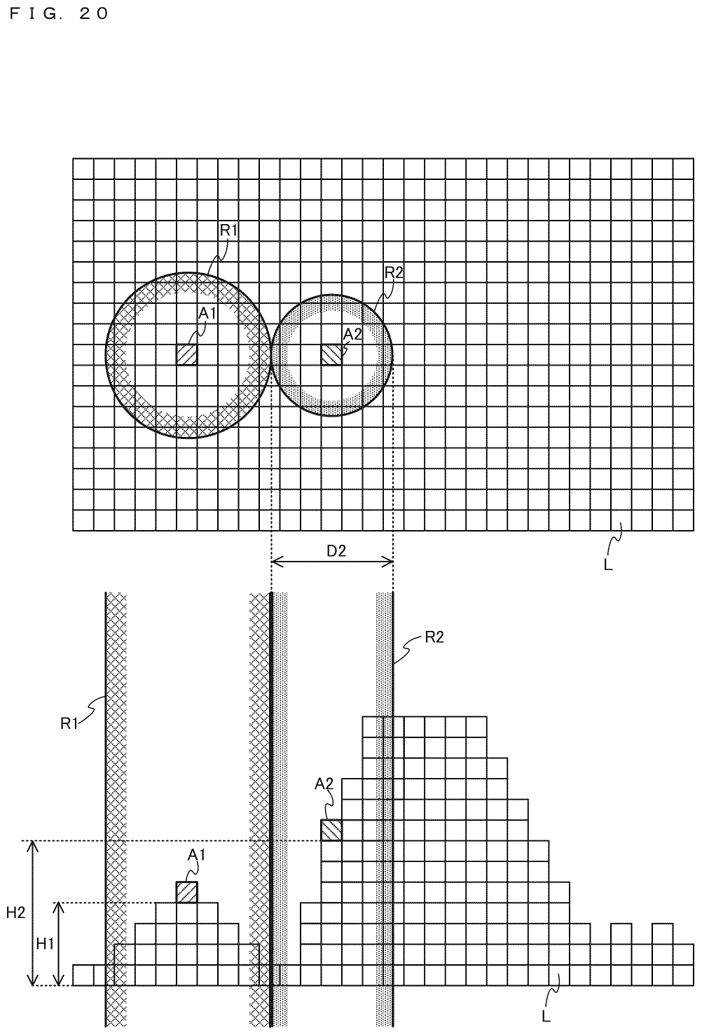

A process executed in the case in which the first region R1 and the second region R2 overlap in the game space in the present example will be described with reference to FIGS. 19 and 20. It should be noted that FIG. 19 is a diagram illustrating an example of a state in which the second region R2 overlaps the first region R1 that has already been set. In FIG. 19, the upper diagram is a top view of the first region R1a and the second region R2 in the game space as viewed from above, and the lower diagram is a side view of the first region R1a and the second region R2 in the game space as viewed laterally. FIG. 20 is a diagram illustrating an example in which the overlapping state of FIG. 19 is removed, and the second region R2 is set. In FIG. 20, the upper diagram is a top view of the first region R1a and the second region R2 in the game space as viewed from above, and the lower diagram is a side view of the first region R1a and the second region R2 in the game space as viewed laterally.

As illustrated in FIG. 19, the first region R1 is formed by a cylindrical space the axis of which is a vertical straight line that passes through the position of the first region setting object A1 that is located at a position having a height H1 in the game space. The extent in the horizontal direction of the first region R1 is set based on the height H1 in the game space at which the first region setting object A1 is arranged.

In the game space in which the first region R1 is thus set by the first player character PC1, a second region setting object A2 is newly arranged at a position having a height H2 higher than the position of the height H1 by the second player character PC2. A second region R2i is provisionally set due to the arrangement of the second region setting object A2. The second region R2i has a cylindrical space the axis of which is a vertical straight line that passes through the position of the second region setting object A2. As illustrated in FIG. 19, a portion of the second region R2i covers a portion of the first region R1 that has already been set. Specifically, since the height H2 at which the second region setting object A2 is arranged is higher than the height H1 at which the first region setting object A1 is arranged, the extent in the horizontal direction of the second region R2i that has a diameter D2i and has a center at the position of the second region setting object A2 is provisionally set so as to be greater than the extent in the horizontal direction of the first region R1.

When a newly set region overlaps an already set region, a region the size of which is reduced by excluding at least the overlap region is set as a new region. For example, when the second region R2i newly set overlaps the first region R1 already set (e.g., a state illustrated in FIG. 19), a second region R2 that does not overlap the first region R1 is set without changing the position of the second region setting object A2 by reducing the extent in the horizontal direction of a region set when the overlapping does not occur while keeping the same shape as the shape of said region. Specifically, as illustrated in FIG. 20, the diameter D2i is reduced to a diameter D2, the center of which is located at the second region setting object A2, while keeping the same cylindrical shape as the shape of a region set when the overlapping does not occur, thereby reducing the extent in the horizontal direction of said region, so that a second region R2 that does not overlap the first region R1 is set. As an example, the diameter D2 is a length that is in contact with the boundary of the first region R1 that has overlapped, and a cylindrical second region R2 that is in contact with the cylindrical first region R1 at the boundaries thereof is set. Thus, when one region overlaps another region, a second region R2 is set that has the same shape (i.e., a cylindrical shape) as the shape of a region set when the overlapping does not occur, whereby it is possible to prevent the range of the second region R2 from becoming difficult to image due to a change in the shape, and the range of the second region R2 set when the overlapping occurs can be easily recognized.

In the present example, as a height in a game space at which a region setting object A is arranged increases, the extent of a region set based on the region setting object A increases, and positions in the vertical direction in the game space at which the region setting object A is arranged are also included in the region. Therefore, a second region setting object A2 cannot be arranged in a space above or below the first region R1 set earlier, and the first region R1 set earlier cannot be removed with a second region R2 set later.

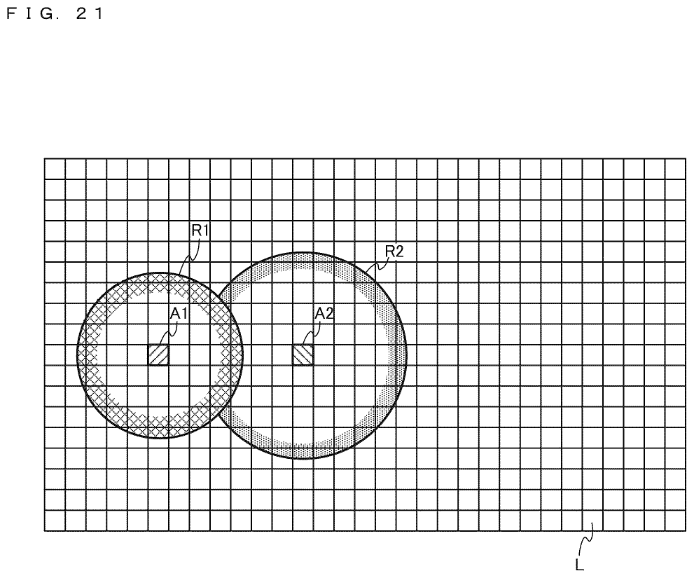

It should be noted that reducing a region set later may include reducing into a region having another shape. Another example in which a region is reduced to a region having another shape in order to remove overlapping of regions will be described with reference to FIG. 21. It should be noted that FIG. 21 is a diagram illustrating another example in which the second region R2 is set by removing the overlapping state of FIG. 19.

In FIG. 21, in another example in which the second region R2 is set by removing the overlapping state, the extent in the horizontal direction of the second region R2i is reduced by removing only a portion overlaying the first region R1 from the second region R2i (see FIG. 19) without changing the position of the second region setting object A2, so that the second region R2 that does not overlap the first region R1 is set. For example, in the example of FIG. 21, the circular shape of the second region R2i as viewed from above in the game space (i.e., the shape illustrated in the top view of FIG. 21) is changed into a crescent shape by removing the portion of the second region R2i overlaying the first region R1 to reduce the extent of the second region R2i, whereby the second region R2 that does not overlap the first region R1 is set. Thus, the second region R2 has the same range as that of the second region R2i, except for a portion thereof overlaying the first region R1.

Thus, when respective regions corresponding to a plurality of player characters overlap, a priority is given to regions set earlier, and regions set later are reduced to remove the overlapping, so that the respective regions are set. Therefore, even when respective regions corresponding to a plurality of player characters overlap, the regions can be set, and can be expanded by arranging region setting objects.

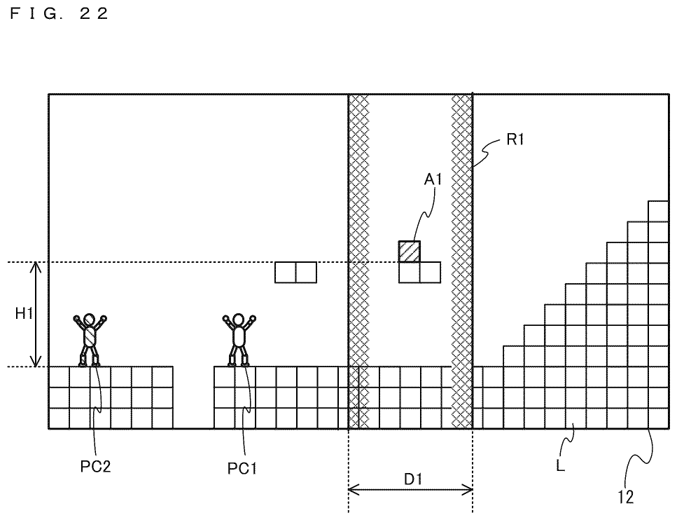

In addition, in the foregoing description, a game in which a three-dimensional virtual space is used as a game space has been described. Alternatively, the present example may be applied to a game in which a two-dimensional game world is used. An example in which a region associated with a player character is set in a two-dimensional game world will be described below with reference to FIG. 22. It should be noted that FIG. 22 is a diagram illustrating an example in which the first region R1 is set in a two-dimensional side-scrolling game.

In the present example, in the case in which the first region R1 is set in a two-dimensional game world, a rectangular or circular region is set as the first region R1. For example, in the example illustrated in FIG. 22, a first player character PC1 and a second player character PC2 are arranged in a game world in a two-dimensional side-scrolling game. In addition, a first region setting object A1 associated with the first player character PC1 is arranged at a position having a height H1 in the game world to set a first region R1 in the game world.

As illustrated in FIG. 22, the first region R1 is set as a region including a position related to the horizontal direction of the first region setting object A1. When the first region R1 is set in the two-dimensional game world, the first region R1 is set so as to include the first region setting object A1 arranged in the game world, i.e., at least a portion of the first region setting object A1 is included as viewed from above in the game world. As an example, the first region R1 is formed by a rectangular space that extends up to a limit height in the vertical direction, the center of the rectangular shape being located at a vertical straight line in the game world that passes through the position of the first region setting object A1 (e.g., a point that is the center of the first region setting object A1 or the center of a lower line). A width D1 in the horizontal direction of the first region R1 is set based on a height H1 in the game space at which the first region setting object A1 is arranged. For example, the width D1 in the horizontal direction of the first region R1 is set so as to increase as the first region setting object A1 is arranged at a higher position. As an example, the width D1 in the horizontal direction of the first region R1 is set so as to be proportional to the height H1 at which the first region setting object A1 is arranged. When the width D1 is less than a predetermined value, the width D1 is set to the predetermined value. In addition, as in the above regions set in a three-dimensional game space, a buffing effect and an editing right are given to the first player character PC1 in the first region R1 set in the game world. Thus, even in a game using a two-dimensional game world, a region associated with each player character can be set as in a game using a three-dimensional game space.

It should be noted that, in the present example, some of a plurality of users playing a game using the above game space may pause to play the game while other users may be allowed to proceed with the game. For example, the first user who pauses to play a game provisionally ends the log-in state (log off) to provisionally end the game, and the first player character PC1 operated by the first user is provisionally removed from the game space. In addition, during the time when the first user pauses to play the game, the game using the game space can be continued by communication between game systems 1 used by other users. Thereafter, when the first user, who has paused to play the game, logs in again in order to resume the game, the first player character PC1, which has once been removed from the game space, is caused to appear again in the same game space, so that the first user can participate again in the game that other users are continuing to play. In the present example, during the time when the first user pauses to play the game, i.e., after the first player character PC1 operated by the first user has once been removed from the game space, the state in which the first region R1 has been set due to the arrangement of the first region setting object A1 associated with the first player character PC1 in the game space may be continued until a predetermined period of time has passed after the start of the pause, in a game between other game systems 1 operated by other users that have been playing the game. Thus, even during the time when the first user pauses to play a game, if the first region R1 associated with the first player character PC1 operated by the first user continues to be set, the game space in the first region R1 can be prevented from being changed by other player characters PC during the pause. In addition, if the period of time for which the first region R1 continues to be set during the pause in the game is limited to the above predetermined period of time, the region of the first user who does not resume the game can be prevented from remaining in the game space for a long period of time and obstructing other users' play. It should be noted that when the first region R1 is removed after the above predetermined period of time has passed during the pause in the game, the first region setting object A1 for which the first region R1 has been set may continue to be arranged without a change in the game space, or may be removed together with the first region R1 from the game space.

In addition, in the first region R1, a limitation is imposed on changing of the state of the game space by characters other than the first player character PC1 that has set the first region R1, and the right to edit the game space is given to the first player character PC1. In another example, in the first region R1, other player characters PC to which the editing right is given may be set in addition to the first player character PC1. For example, a third player character PC3 that is different from the first player character PC1 and the second player character PC2 and satisfies a predetermined condition may be given the editing right to change the state of the game space in the first region R1 associated with the first player character PC1. As an example, the predetermined condition may be that a player character PC (third player character PC3) is operated by a user who has a predetermined relationship with the first user who operates the first player character PC1 having the editing right (e.g., a third user having a friendship with the first user, or a third user designated by the first user), that a player character PC has a particular piece of equipment (wearing a particular piece of clothing, carrying a particular item, or the like), or the like.

Although at least the right to edit the game space in the first region R1 is given to the third player character PC3 that satisfies the predetermined condition, the above buffing effect in the first region R1 may or may not be given to the third player character PC3. In addition, although the third player character PC3 can arrange a third region setting object A3 in the game space according to the third user's operation to set a third region R3 associated with the third player character PC3, the first player character PC1 may also be able to change the state of the game space in the third region R3 if the third user has a predetermined relationship with the first user. In this case, at least the right to edit the game space in the third region R3 is given to the first player character PC1, and the above buffing effect may or may not be given to the third region R3.

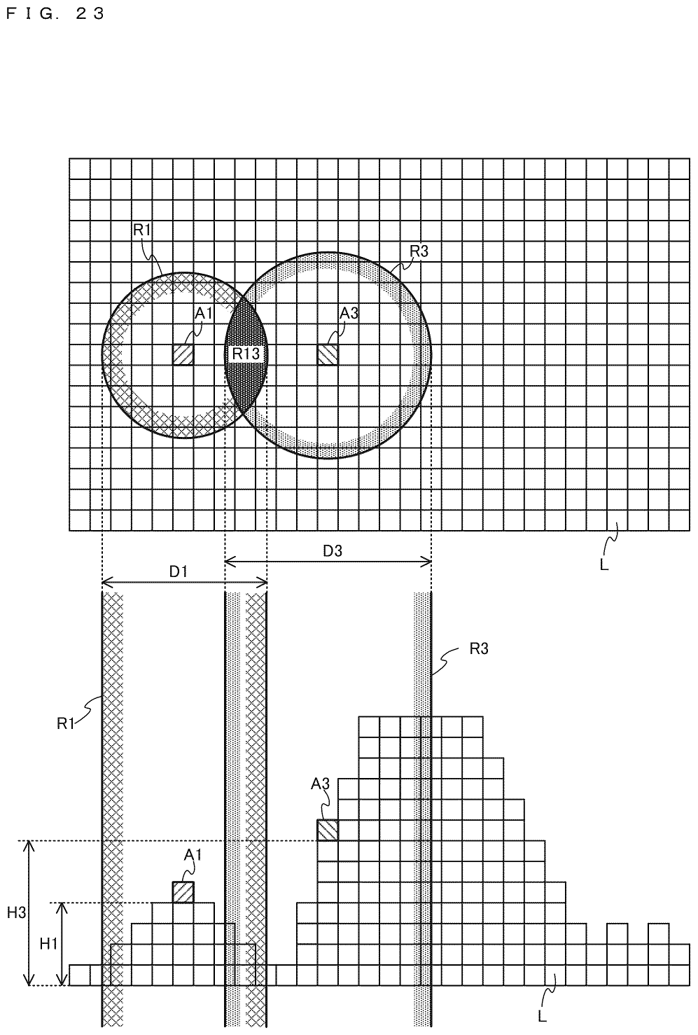

In addition, in the case in which the first region R1 associated with the first player character PC1 and the third region R3 associated with the third player character PC3 satisfying the predetermined condition overlap in the game space, the respective regions may be set directly without excluding the overlap region. A region that is set when the first region R1 and the third region R3 overlap will be described below with reference to FIG. 23. It should be noted that FIG. 23 is a diagram illustrating an example of respective regions that are set when the third region R3 overlaps the first region R1 already set. In FIG. 23, the upper diagram is a top view of a first region R1a and the third region R3 in the game space as viewed from above, and the lower diagram is a side view of the first region R1a and the third region R3 in the game space as viewed laterally.

As illustrated in FIG. 23, the first region R1 is formed by a cylindrical space the axis of which is a vertical straight line that passes through the position of the first region setting object A1 that is located at a position having a height H1 in the game space. In addition, the extent in the horizontal direction of the first region R1 (diameter D1) is set based on the height H1 in the game space at which the first region setting object A1 is arranged.

In the game space in which the first region R1 is thus set by the first player character PC1, a third region setting object A3 is newly arranged at a position having a height H3 higher than the position having the height H1 by the third player character PC3. A third region R3 set by the arrangement of the third region setting object A3 is a cylindrical space the axis of which is a vertical straight line passing through the position of the third region setting object A3. In addition, the height H3 at which the third region setting object A3 is arranged is higher than the height H1 at which the first region setting object A1 is arranged. Therefore, the third region R3 the extent in the horizontal direction of which is a diameter D3, the center of which is located at the position of the third region setting object A3, is provisionally set so as to be larger (diameter D3) than the extent in the horizontal direction of the first region R1. In addition, as illustrated in FIG. 23, a portion of the third region R3 overlays a portion of the first region R1 at an overlap region R13.

In the case in which regions associated with respective player characters PC operated by a first and a third user who have a predetermined relationship are provisionally set so as to overlap, the regions may be set with the overlapping state allowed. For example, in the state illustrated in FIG. 23 in which the first region R1 and the third region R3 overlap, the first region R1 and the third region R3 are set in an overlapping state in which the overlap region R13 is allowed. Here, the editing right to change the state of the game space in the overlap region R13 is given to the first player character PC1 and the third player character PC3, and the same buffing effect is given to the first player character PC1 and the third player character PC3 in the overlap region R13. Therefore, the editing right to change the state of the game space is given to both of the first player character PC1 and the third player character PC3 in all of the first region R1, the third region R3, and the overlap region R13. Meanwhile, as an example, the same buffing effect may be given to both of the first player character PC1 and the third player character PC3 even in all of the first region R1, the third region R3, and the overlap region R13. As another example, the same buffing effect may be given to both of the first player character PC1 and the third player character PC3 in the overlap region R13, while the buffing effect may only be given to the first player character PC1 in the first region R1 excluding the overlap region R13, and the buffing effect may only be given to the third player character PC3 in the third region R3 excluding the overlap region R13.

In the case in which regions associated with player characters PC operated by a plurality of users that do not have the predetermined relationship overlap as described above, a region the size of which is reduced by excluding at least the overlap region is set as a new region. In contrast to this, regions associated with respective player characters PC operated by a first and a third user who have the predetermined relationship can be set so as to overlap, and therefore, a relatively large region can be set.

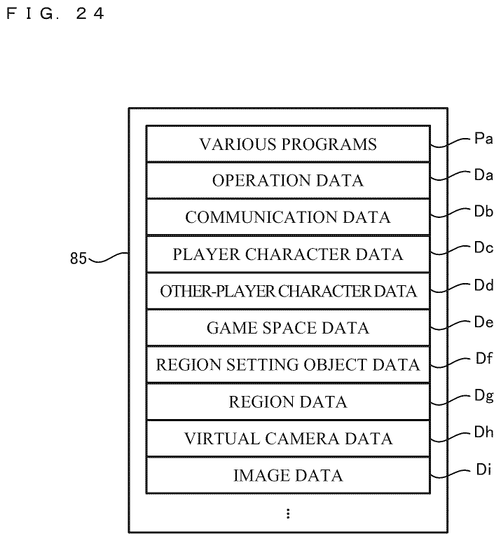

Next, an example of a specific process that is executed in the game system 1 will be described with reference to FIG. 24. FIG. 24 is a diagram illustrating an example of a data area set in the DRAM 85 of a main body apparatus 2. It should be noted that in addition to the data of FIG. 24, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, a communication program for communicating with other apparatuses (the server 102 and other game systems 1), and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, communication data Db, player character data Dc, other-player character data Dd, game space data De, region setting object data Df, region data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The communication data Db includes transmission data to be transmitted to other apparatuses (the server 102 and other game systems 1) and reception data received from other apparatuses. For example, the transmission data includes information about the action, state, and the like of a player character PC operated by the user of the game system 1, information about a game space changed by the player character PC's action, and the like. In addition, the reception data includes information about the actions, states, and the like of other player characters PC operated by the users of other game systems 1, information about a game space changed by the other player characters PC, and the like.

The player character data Dc indicates parameters such as the position, direction, pose, action, state, remaining energy, and the like in a game space of a player character operated by the user of the game system 1 (hereinafter referred to as a first player character PC1), and the like. The other-player character data Dd indicates parameters such as the positions, directions, poses, actions, states, remaining energies, and the like in a game space of other player characters operated by the users of other game systems 1 (hereinafter referred to as a second player character PC2), and the like.

The game space data De indicates the state of a game space. For example, the game space data De indicates a parameter related to the state of an object L for each coordinate point set in a game space, i.e., a parameter indicating whether or not an object L exists at each of a plurality of coordinate points, and parameters indicating the type, state, and the like of an existing object L.

The region setting object data Df indicates the position, state, and the like in a game space of a region setting object A associated with each player character PC.

The region data Dg indicates the position and shape in a game space of a region associated with each player character PC.

The virtual camera data Dh indicates the position, direction, angle of view, and the like of a virtual camera arranged in a game space.

The image data Di is for displaying images (e.g., an image of each player character PC, an image of each object, and a background image) on a display screen (e.g., the display 12 of the main body apparatus 2).

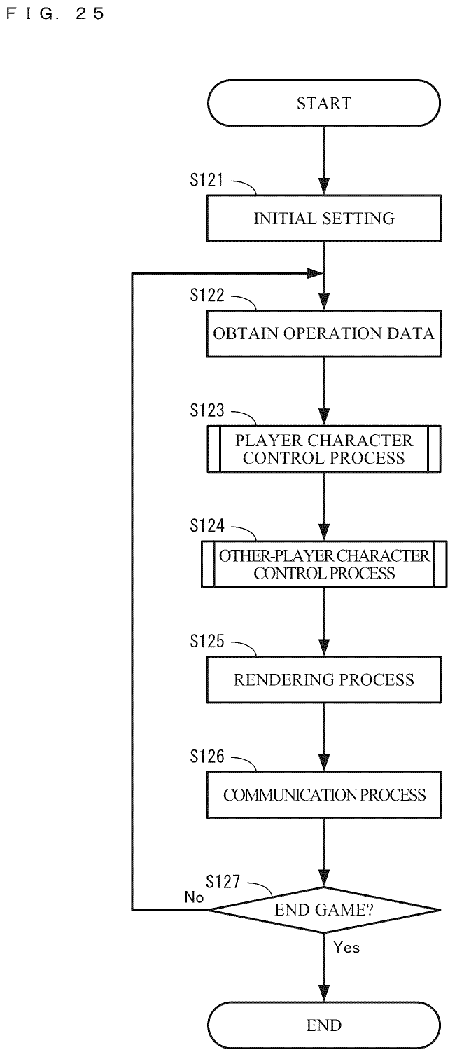

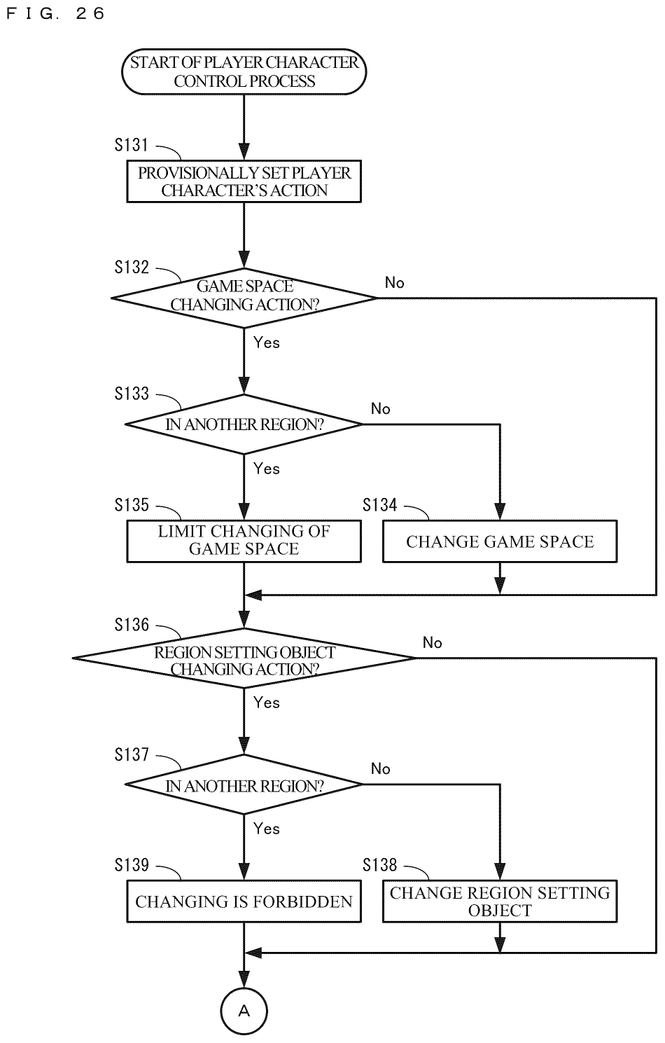

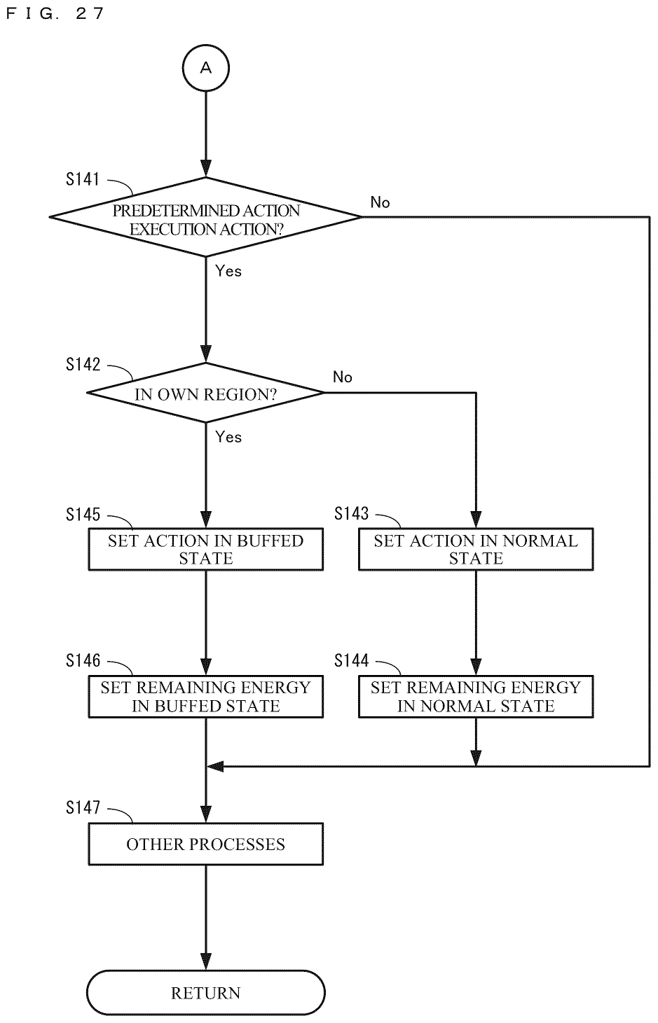

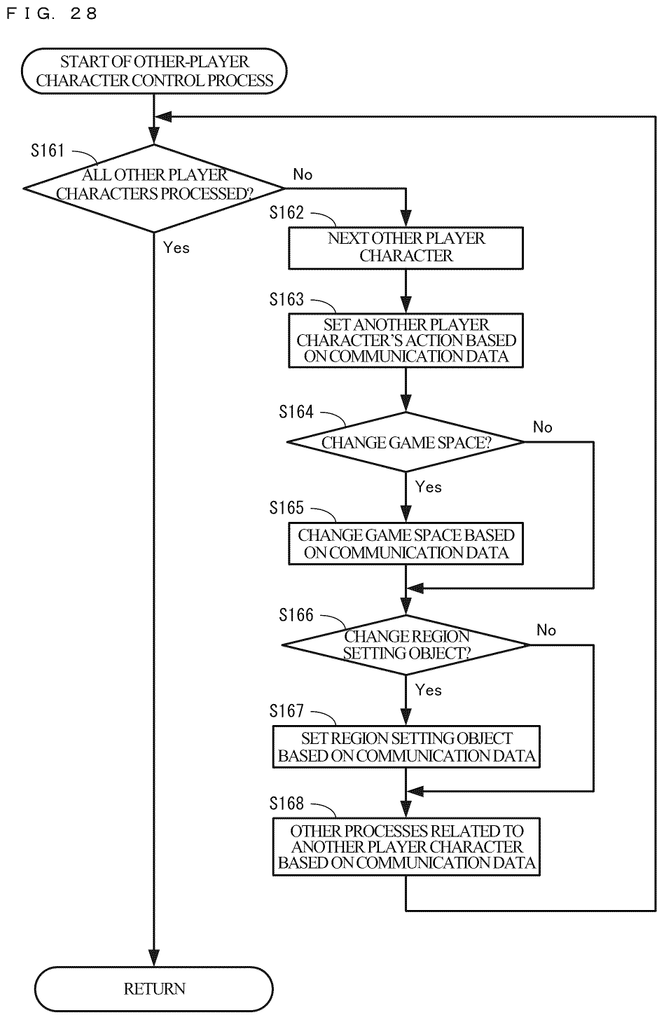

Next, a detailed example of a game process that is an example of an information process in the present example will be described with reference to FIGS. 25 to 28. FIG. 25 is a flowchart indicating an example of a game process executed in the game system 1. FIG. 26 is a subroutine indicating an example of a first stage of a player character control process in step S123 of FIG. 25. FIG. 27 is a subroutine indicating an example of a second stage of the player character control process in step S123 of FIG. 25. FIG. 28 is a subroutine indicating an example of an other-player character control process in step S124 of FIG. 25. In the present example, a series of steps illustrated in FIGS. 25 to 28 is executed by the processor 81 executing a predetermined application program (game program), a communication program, and the like included the programs Pa. The game process of FIGS. 25 to 28 is started with any appropriate timing.

It should be noted that the steps in the flowcharts of FIGS. 25 to 28, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., the server 102 and other game systems 1 that can communicate with the main body apparatus 2 via a network). Specifically, the steps of FIGS. 25 to 28 may be executed by a plurality of information processing apparatuses including the main body apparatus 2 cooperating with each other.

In FIG. 25, the processor 81 executes initial setting for the game process (step S121), and proceeds to the next step. For example, in the initial setting, the processor 81 initializes parameters for executing processes described below, and updates each data. As an example, in the case in which it is necessary to log in on the server 102 in order to start a game in which a plurality of users participate, the processor 81 performs a log-in process on the server 102 according to a log-in operation indicated by the operation data Da. The processor 81 obtains data related to a game space that has been allocated to the user by the log-in process, and produces a game space based on the data. Thereafter, the processor 81 arranges a first player character PC1, a virtual camera, and the like in a predetermined pose or orientation at a default position in the game space, and updates the player character data Dc, the game space data De, and the virtual camera data Dh. In addition, the processor 81 sets a first region R1 based on the position of a first region setting object A1 associated with the first player character PC1 in the game space according to a situation of the first region setting object A1(e.g., when a game is started from the beginning, the first region setting object A1 is arranged at a default position, and when a game is resumed from the middle, or a situation before a pause in a game is set based on data obtained in the log-in process and the like), and sets the region setting object data Df and the region data Dg.

Next, the processor 81 obtains operation data from the left controller 3, the right controller 4, and/or the main body apparatus 2, and updates the operation data Da (step S122), and proceeds to the next step.

Next, the processor 81 performs a player character control process (step S123), and proceeds to step S124. The player character control process in step S123 will be described below with reference to FIG. 26.

In FIG. 26, the processor 81 performs a process of provisionally setting the first player character PC1's action (step S131), and proceeds to the next step. For example, the processor 81 provisionally sets the first player character PC1's action based on the operation data Da and the player character data Dc. As an example, the processor 81 provisionally sets the position, direction, pose, action, state, and the like of the first player character PC1 based on an operation input indicated by the operation data Da, virtual physical calculation in the game space (e.g., virtual inertia and gravity), and the like.

Next, the processor 81 determines whether or not the first player character PC1's action of changing the game space has been provisionally set (step S132). For example, the processor 81 looks up the player character data Dc. If the first player character PC1's action of changing the game space (an action involving, for example, arranging, moving, or removing an object L or the like) has been provisionally set, the result of the determination in step S132 by the processor 81 is positive. If the first player character PC1's action of changing the game space has been provisionally set, the processor 81 proceeds to step S133. Otherwise, i.e., if the first player character PC1's action of changing the game space has not been provisionally set, the processor 81 proceeds to step S136.

In step S133, the processor 81 determines whether or not the first player character PC1's action of changing the game space in another region associated with a player character PC (second player character PC2) operated by another user has been provisionally set. For example, the processor 81 looks up the player character data Dc. If the first player character PC1's action of changing the game space in a second region R2 (an action involving, for example, arranging, moving, or removing an object L or the like in the second region R2) has been provisionally set, the result of the determination in step S133 by the processor 81 is positive. If the first player character PC1's action of changing the game space outside the another region has been provisionally set, the processor 81 proceeds to step S134. Otherwise, i.e., if the first player character PC1's action of changing the game space in the another region has been provisionally set, the processor 81 proceeds to step S135.

In step S134, the processor 81 approves the first player character PC1's action provisionally set, performs a process of changing the game space based on said action, and proceeds to step S136. For example, the processor 81 approves the first player character PC1's action provisionally set, and updates the player character data Dc. Thereafter, if changing such as arranging, moving, or removing of an object L has been performed by the approved action, the processor 81 updates the game space data De by updating the parameter of an object L set for a coordinate point set in the game space according to the change.

In step S135, the processor 81 performs a process of imposing a limitation on changing the game space based on the first player character PC1's action provisionally set, and proceeds to step S136. For example, the processor 81 maintains the state of the game space in the another region (the second region R2), sets the first player character PC1's action that does not perform changing such as arranging, moving, or removing of an object L, and updates the player character data Dc.

In step S136, the processor 81 determines whether or not the first player character PC1's action of changing the region setting object A has been provisionally set. If the first player character PC1's action of changing the region setting object A has been provisionally set, the processor 81 proceeds to step S137. Otherwise, i.e., if the first player character PC1's action of changing the region setting object A has not been provisionally set, the processor 81 proceeds to step S138.

In step S137, the processor 81 determines whether or not the first player character PC1's action of changing the region setting object A has been temporarily set in another region associated with a player character PC (second player character PC2) operated by another user. For example, if the first player character PC1's action of moving or removing a second region setting object A2 arranged in the second region R2 has been provisionally set, or if the first player character PC1's action of arranging a first region setting object A1 in the second region R2 has been provisionally set, the result of the determination in step S137 by the processor 81 is positive. If the first player character PC1's action of changing a region setting object A in the another region has been provisionally set, the processor 81 proceeds to step S139. Otherwise, i.e., if the first player character PC1's action of changing a region setting object A outside the another region has been provisionally set, the processor 81 proceeds to step S138.

In step S138, the processor 81 approves the first player character PC1's action provisionally set, performs a process of changing the first region setting object A1 based on the action, sets a first region R1 based on the position of the first region setting object A1, and proceeds to step S141 (see FIG. 27). For example, the processor 81 approves the first player character PC1's action provisionally set, and updates the player character data Dc. As a first example, if the first region setting object A1 is moved in the game space by the approved action, the processor 81 sets the new position of the moved first region setting object A1, and updates the region setting object data Df. As a second example, if the first region setting object A1 is removed from the game space by the approved action, the processor 81 removes the position of the first region setting object A1, updates the region setting object data Df, removes the first region R1 that has been set based on the position of the first region setting object A1 before the removal, and updates the region data Dg. As a third example, if the first region setting object A1 is arranged in the game space by the approved action, the processor 81 updates the region setting object data Df with the position of the first region setting object A1 newly arranged in the game space. In addition, the processor 81 removes the first region R1 that has been set based on the first region setting object A1 before the arrangement, newly sets a first region R1 in the game space based on the position of the first region setting object A1 newly arranged, and updates the region data Dg. It should be noted that, in the third example, if the first region R1 newly set overlaps another region such as the second region R2 already set in association with the second player character PC2, the processor 81 sets and adjusts the size of the first region R1 so as to avoid the overlapping, and updates the region data Dg.

Referring to FIG. 27, in step S141, the processor 81 determines whether or not the first player character PC1's action of performing a predetermined motion has been provisionally set. For example, if the first player character PC1's action of performing a predetermined motion (e.g., an action for the buffing effect) has been provisionally set in step S131, the result of the determination in step S132 by the processor 81 is positive. If the first player character PC1's action of performing a predetermined motion has been provisionally set, the processor 81 proceeds to step S142. Otherwise, i.e., if the first player character PC1's action of performing a predetermined motion has not been provisionally set, the processor 81 proceeds to step S147.

In step S142, the processor 81 determines whether or not the first player character PC1's action of performing a predetermined motion in its own region associated with the first player character PC1 has been provisionally set. For example, if the first player character PC1's action described above to be performed in the first region R1 associated with the first player character PC1 indicated by the region data Dg has been provisionally set in step S131, the result of the determination in step S142 by the processor 81 is positive. If the first player character PC1's action described above to be performed in in another region associated with a player character PC operated by another user (second player character PC2) indicated by the region data Dg or outside a region that does not belong to any region associated with each player character PC indicated by the region data Dg has been provisionally set, the processor 81 proceeds to step S143. Otherwise, i.e., if the first player character PC1's action described above to be performed in the own region has been provisionally set, the processor 81 proceeds to step S145.

In step S143, the processor 81 sets the first player character PC1's action in a normal state, and proceeds to the next step. For example, the processor 81 sets the first player character PC1's action in a normal state without adding a buffing effect (e.g., without an increase in movement speed as in a process in step S145 described below) to the first player character PC1's action provisionally set in step S131, and updates the player character data Dc.

Next, the processor 81 sets remaining energy according to the first player character PC1's action in a normal state (step S144), and proceeds to step S147. For example, if the action set in step S143 is an action of reducing remaining energy, which is an example of a parameter set for the first player character PC1, the processor 81 sets and subtracts the amount of a reduction in the remaining energy for a normal value according to the action, and updates the player character data Dc using the reduced remaining energy.

In step S145, the processor 81 sets the first player character PC1's action in a buffed state, and proceeds to the next step. For example, the processor 81 sets the first player character PC1's action in a buffed state by adding a buffing effect such as increasing movement speed to the first player character PC1's action provisionally set in step S131, and updates the player character data Dc.

Next, the processor 81 sets remaining energy according to the first player character PC1′s action in a buffed state (step S146), and proceeds to step S147. For example, if the action set in step S145 is an action of reducing the remaining energy, the processor 81 relatively reduces the amount of a reduction in the remaining energy (e.g., the reduction amount is zero), and updates the player character data Dc with the reduced remaining energy.

In step S147, the processor 81 performs other processes related to the first player character PC1, and ends the subroutine. As an example of other processes related to the first player character PC1, the processor 81 causes the first player character PC1 to perform an action in the game space based on an action of performing a predetermined motion for which the result of the determination in step S141 is positive (e.g., an action to produce the buffing effect), of the first player character PC1's actions provisionally set in step S131, and updates the player character data Dc. As another example, the processor 81 calculates the first player character PC1's game score based on the results of the player character control process that have been executed until the current time, and updates the player character data Dc.

Referring back to FIG. 25, after the player character control process in step S123, the processor 81 performs an other-player character control process (step S124), and proceeds to step S125. The other-player character control process in step S124 will be described below with reference to FIG. 28.

In FIG. 28, the processor 81 determines whether or not all of steps S162 to S168 have been completed for all other player characters PC arranged in the game space (step S161). If steps S162 to S168 have not been completed for all other player characters PC, the processor 81 proceeds to step S162. Otherwise, i.e., if steps S162 to S168 have been completed for all other player characters PC, the processor 81 ends the subroutine.

In step S162, the processor 81 chooses a player character PC for which steps S162 to S168 have not been completed, of all other player characters PC arranged in the game space, and proceeds to the next step.

Next, the processor 81 sets an action of another player character PC that is to be processed, based on the communication data Db (step S163), and proceeds to the next step. For example, the processor 81 retrieves, from the communication data Db, information about another player character PC to be processed that is received from the game system 1 of another user who is operating the another player character PC, sets the another player character PC's action based on said information, and updates the other-player character data Dd. It should be noted that, in the game system 1 of the another user, processes including step S123 are performed on the player character PC operated by the another user, and said game system 1 transmits communication data generated according to the result of the processes. Thereafter, in step S126 described below, data transmitted from the game system 1 of another user is received and stored into the communication data Db as appropriate, and in step S163 or steps S164 to S168 described below, the data thus stored in the communication data Db is used.

Next, the processor 81 determines, based on the communication data Db, whether or not the game space has been changed by an action of another player character PC to be processed (step S164). For example, the processor 81 determines whether or not the game space has been changed by another player character PC to be processed, based on information about the game space received from the game system 1 of the another user operating the another player character PC. If the game space has been changed by the another user operating the another player character PC to be processed, the processor 81 proceeds to step S165. Otherwise, i.e., if the game space has not been changed by the another user operating the another player character PC to be processed, the processor 81 proceeds to step S166.

In step S165, the processor 81 performs a process of changing the game space based on an action of the another player character PC to be processed, based on the communication data Db, and proceeds to step S166. For example, the processor 81 retrieves, from the communication data Db, information about the game space changed by the action of another player character PC to be processed that has been received from the game system 1 of another user operating the another player character PC. Thereafter, based on the information, the processor 81 updates a parameter at a coordinate point in the game space related to an object L changed by the action of the another player character PC to be processed, to update the game space data De.

In step S166, the processor 81 determines, based on the communication data Db, whether or not the another player character PC to be processed has changed a region setting object A associated with the another player character PC. For example, the processor 81 determines whether or not the another player character PC to be processed has changed the region setting object A, based on information related to the another player character PC to be processed that has been received from the game system 1 of another user operating the another player character PC, or information about the game space. If the region setting object A has been changed by an action of the another player character PC to be processed, the processor 81 proceeds to step S167. Otherwise, i.e., if the region setting object A has not been changed by an action of the another player character PC to be processed, the processor 81 proceeds to step S168.

In step S167, the processor 81 performs a process of changing the region setting object A associated with the another player character PC to be processed, based on the communication data Db, sets a region R based on the position of the region setting object A, and proceeds to step S168. As a first example, when the region setting object A is moved in the game space by an action of the another player character PC to be processed, the processor 81 sets a new position of the region setting object A after the movement, and updates the region setting object data Df. As a second example, when the region setting object A is removed from the game space by an action of the another player character PC to be processed, the processor 81 removes the position of the region setting object A, updates the region setting object data Df, removes the region R that has been set based on the position of the region setting object A before the removal, and updates the region data Dg. As a third example, when a region setting object A is arranged in the game space by an action of the another player character PC to be processed, the processor 81 updates the region setting object data Df with the position newly arranged in the game space. In addition, the processor 81 removes the region R that has been set based on the region setting object A before the arrangement, based on information related to the game space in the communication data Db, and newly sets a region R based on the position of the region setting object A newly set, in the game space, and updates the region data Dg.

In step S168, the processor 81 performs another process related to the another player character PC to be processed, and ends the subroutine. For example, as an example of the another process related to the another player character PC to be processed, the processor 81 calculates the game score of the another player character PC to be processed, based on the communication data Db and the result of the player character control process that has been executed until the current time, and updates the other-player character data Dd.

Referring back to FIG. 25, after the other-player character control process in step S124, the processor 81 performs a rendering process (step S125), and proceeds to the next step. For example, the processor 81 sets a game space including a plurality of objects L, and a region setting object A and a region R associated with each player character PC, based on the game space data De, the region setting object data Df, and the region data Dg. In addition, the processor 81 arranges and causes each player character PC to perform an action in the game space based on the player character data Dc and the other-player character data Dd. In addition, the processor 81 sets the position and/or orientation of a virtual camera for producing a display image based on the virtual camera data Dh to arrange the virtual camera in the game space. Thereafter, the processor 81 generates an image of the game space as viewed from the virtual camera thus set, and controls the display 12 so that the game space image is displayed on the display 12. It should be noted that the processor 81 may execute a process of controlling the movement of the virtual camera in the game space based on the position and pose of the first player character PC1, and update the virtual camera data Dh. In addition, the processor 81 may move the virtual camera in the game space based on the operation data Da, and updates the virtual camera data Dh.

Next, the processor 81 performs a communication process (step S126), and proceeds to the next step. For example, the processor 81 prepares transmission data to be transmitted to each of other game systems 1, stores the transmission data into the communication data Db, and transmits the transmission data to the other game systems 1 through the server 102. As an example, the processor 81 prepares information related to the action, state, and the like of a player character PC operated by the user (the first player character PC1) based on the player character data Dc, and stores the information as a portion of the transmission data into the communication data Db. In addition, the processor 81 prepares, based on the game space data De, the region setting object data Df, and the region data Dg, information related to the game space changed by the player character PC operated by the user, information related to the first region setting object A1 associated with the player character PC operated by the user, and information related to the first region R1 associated with the player character PC operated by the user, as information related to the game space changed by an action of the player character PC, and stores the prepared information as the transmission data into the communication data Db. In addition, the processor 81 stores reception data received from other game systems 1 through the server 102 into the communication data Db.

Next, the processor 81 determines whether or not to end the game process (step S127). In step S127, the game process is ended, for example, if a condition for ending the game process is satisfied, the user has performed an operation of ending the game process, the user has performed an operation of logging off, or the like. If the processor 81 determines not to end the game process, the processor 81 returns to and repeats step S122. Otherwise, i.e., if the processor 81 determines to end the game process, the processor 81 transmits data indicating ending of the game to the server 102, and ends the flowchart. Following this, steps S122 to S127 are repeatedly executed until the processor 81 determines to end the game process in step S127.

It should be noted that the server 102, when receiving data indicating ending of a game from a game system 1, removes a player character PC operated by the user of the game system 1 (the first player character PC1) from the game space. Thereafter, the server 102, when receiving log-in data indicating resumption of the game from the game system 1, may cause the player character PC that has once been removed from the game space (the first player character PC1) to appear in the same game space, and resume the game. In addition, after the user has once paused to play a game, i.e., the first player character PC1 operated by the user has once been removed from the game space, if the game is still being performed by another game system 1 operated by another user that has played the game, a state in which the first region R1 has been set by the arrangement of the first region setting object A1 associated with the first player character PC1 in the game space may be continued until a predetermined period of time has passed since the pause. The state in which a region associated with a player character PC operated by a user is set is continued even during the time when the user pauses to play a game, and therefore, other player characters PC can be prevented from changing the game space in the region during the pause. In addition, the period of time during which the region continues to be set during the pause in the game is limited to the predetermined period of time, and therefore, the region of a user who does not resume a game can be prevented from remaining in the game space for a long period of time and obstructing other users' play.

Thus, in the present example, a region in which a buffing effect or an editing right is given to a player character PC can be set according to a user's operation of arranging a region setting object, and the position and size of the region are automatically set based on the position of the region setting object. Therefore, the position and extent of a region set in the game space can be set based on a user's simple operation. In addition, in the present example, by setting the first region R1 associated with the first player character PC1, a limitation is imposed on changing of the state of the game space in the first region R1 that is performed by other player characters PC. Therefore, in a game space shared by a plurality of users, a region in which a limitation is imposed on changing of the state of the game space that is performed by other users.

It should be noted that, in the first region R1, in addition to a buffing effect and the effect of giving an editing right, other effects may be obtained. As an example, when the first player character PC1 arranges a predetermined object in the first region R1, the predetermined object may be changed to another object. As another example, when the first player character PC1 arranges a predetermined object in the first region R1, the predetermined object may be changed to a non-player character or the like.

In addition, a region setting object A may have other functions in addition to the above function. As an example, when a game is over for a player character PC, a position in a game space at which the player character PC respawns may be in the vicinity of a region setting object A arranged by the player character PC. As another example, the destination of an object such as an item sent to a player character PC from another player character PC may be in the vicinity of a region setting object A arranged by the player character PC.

In addition, in the above example, a region setting object A carried or stored by a player character PC is arranged in a game space by the player character PC's arrangement action. Alternatively, a region setting object A may be arranged in a game space according to a user's operation without through a player character PC. For example, a region setting object A associated with a user may be arranged at a position (coordinate point) in a game space specified by the user performing a user specification operation of directly specifying the position in the game space. In that case, a player character operated by the user may not appear in the game space, and the editing right to change the game space is only given to the user who has arranged the region setting object A, in a region R set by the region setting object A. In addition, in the present example, objects other than objects L and region setting objects A may be able to be arranged at a position on objects L constituting a ground surface in a game space. In that case, other objects may also be arranged in a game space by a player character PC's arrangement action, or according to a user's operation without through a player character PC.

In addition, in the present example, a public region in which an editing right and a buffing effect are given to all player characters PC arranged in a game space may be set in the game space. For example, by arranging a public region setting object for setting the public region in the game space, a public region having a shape similar to that of the above first region R1 may be set with reference to the position of the public region setting object. It should be noted that the public region setting object may be previously arranged in a game space during the start of a game, or may be arranged at a predetermined position when a predetermined acquisition condition is satisfied, e.g., when at least one player's level reaches a predetermined level or accomplishes a mission, or may be arranged when another character drops the public region setting object or when another character is beaten, or may be obtained from an object different from the public region setting object. In addition, when a particular action is performed on a particular object, the particular object may be changed to the public region setting object.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc.

(computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is useful as an information processing system, information processing program, information processing apparatus, information processing method, and the like that allow optimization of a user's operation required for setting a region in a virtual space, for example.

What is claimed is:

1. An information processing system comprising:
one or more processors; and
one or more memories storing a program that, when executed, causes the information processing system to perform operations including:
changing a state of a virtual space including at least a plurality of first objects by performing at least one of arrangement, movement, and removal of at least one of the first objects and a second object that is associated with each user, at, to, and from a position in the virtual space specified based on a user's input;
setting, in the virtual space, a region having an extent in a horizontal direction set based on a height in the virtual space at which the second object associated with the user is arranged based on the user's input, and including a position related to the horizontal direction of the second object, as a first region related to the user, the region being a two-dimensional or three-dimensional region; and
limiting changing of the state of the virtual space in the first region without the user's input to change the state of the virtual space being performed.

2. The information processing system according to claim 1, wherein
the setting the first region includes setting the first region such that the extent increases as the second object is arranged at a greater height in the virtual space.

3. The information processing system according to claim 1, wherein
the limiting includes limiting further changing of the state of the virtual space in the first region that occurs when the second object is arranged, or the state of the virtual space in the first region after being changed based on the user's input.

4. The information processing system according to claim 1, wherein
further, a state of a virtual space that is the same as the virtual space including at least the plurality of first objects is changed by performing at least one of arrangement, movement, and removal of at least one of the first and second objects at, to, and from a position in the virtual space specified based on an input performed by another user that is different from the user, and
the limiting includes limiting changing of the state of the virtual space in the first region based on the another user's input.

5. The information processing system according to claim 4, wherein
the limiting includes limiting arrangement of at least one of the first and second objects in the first region based on the another user's input.

6. The information processing system according to claim 5, wherein
the setting the first region includes setting the first region such that the extent increases as the second object is arranged at a greater height in the virtual space, and a position in a vertical direction in the virtual space at which the second object is arranged is included in the first region.

7. The information processing system according to claim 4, wherein
the limiting includes limiting removal of at least one of the first and second objects in the first region based on the another user's input.

8. The information processing system according to claim 4, wherein
the limiting includes limiting movement of at least one of the first and second objects in the first region based on the another user's input.

9. The information processing system according to claim 1, wherein
further, a state of a virtual space that is the same as the virtual space including at least the plurality of first objects is changed by performing at least one of arrangement, movement, and removal of at least one of the first and second objects at, to, and from a position in the virtual space specified based on another user's input,
setting, in the virtual space, a region having an extent in the horizontal direction set based on a height in the virtual space at which the second object associated with the another user is arranged based on the another user's input, and including a position related to the horizontal direction of the second object, as a second region related to the another user; and
the limiting includes limiting changing of the state of the virtual space in the second region without the another user's input to change the state of the virtual space being performed.

10. The information processing system according to claim 9, wherein
the setting the first region includes, when the first region to be set overlaps the second region already set, setting, as the first region, a region having a size reduced by excluding at least the overlap region.

11. The information processing system according to claim 10, wherein
the setting the first region includes, when the first region to be set overlaps the second region already set, setting the first region that does not overlap the second region, by causing the first region to have the same shape as that of a region set when the overlapping does not occur and to have an extent obtained by reducing an extent in the horizontal direction of the region.

12. The information processing system according to claim 1, wherein
the virtual space is a three-dimensional virtual space.

13. The information processing system according to claim 1, wherein
the first region has an extent in the horizontal direction, the center of the extent being located at the position of the second object.

14. The information processing system according to claim 13, wherein
the first region includes a circle in the horizontal direction, the center of the circle being located at the position of the second object.

15. The information processing system according to claim 14, wherein
the first region is in the shape of a cylinder, the axis of the cylinder being a vertical straight line in the virtual space passing through the position of the second object.

16. The information processing system according to claim 14, wherein
the first region is in the shape of a hemisphere-cylinder that is a combination of a cylinder, the axis of the cylinder being a vertical straight line in the virtual space passing through the position of the second object, and a hemisphere, the center of the hemisphere being located at the position of the second object and the pole of the hemisphere being located above the second object.

17. The information processing system according to claim 1, wherein
the setting the first region includes, when the second object setting the first region is moved in the virtual space, setting the first region in the virtual space again based on the position after the movement.

18. The information processing system according to claim 1, wherein
the setting the first region includes, when the second object setting the first region is moved in the virtual space, causing the first region to continue to be set during the movement, and when rearranging the second object in the virtual space after the end of the movement, removing the first region continuing to be set, and setting a new first region in the virtual space based on the position of the rearranged second object.

19. The information processing system according to claim 4, wherein
the setting the first region includes causing the first region to continue to be set even during a period of time when the user who has set the second object temporarily pauses to play a game using the virtual space, and
the limiting includes limiting changing of the state of the virtual space in the first region based on the another user's input even during the period of time.

20. The information processing system according to claim 19, wherein
the setting the first region includes removing the setting of the first region from the virtual space when the user who has set the second object continues to pause even after a period of time has passed since the pause.

21. A non-transitory computer-readable storage medium having stored therein a program that, when executed, causes one or more processors of an information processing apparatus to execute information processing comprising:
changing a state of a virtual space including at least a plurality of first objects by performing at least one of arrangement, movement, and removal of at least one of the first objects and a second object that is associated with each user, at, to, and from a position in the virtual space specified based on a user's input;
setting, in the virtual space, a region having an extent in a horizontal direction set based on a height in the virtual space at which the second object associated with the user is arranged based on the user's input, and including a position related to the horizontal direction of the second object, as a first region related to the user, the region being a two-dimensional or three-dimensional region; and
limiting changing of the state of the virtual space in the first region without the user's input to change the state of the virtual space being performed.

22. An information processing apparatus comprising:
one or more processors; and
one or more memories storing a program that, when executed, causes the information processing apparatus to perform operations including:
changing a state of a virtual space including at least a plurality of first objects by performing at least one of arrangement, movement, and removal of at least one of the first objects and a second object that is associated with each user, at, to, and from a position in the virtual space specified based on a user's input;
setting, in the virtual space, a region having an extent in a horizontal direction set based on a height in the virtual space at which the second object associated with the user is arranged based on the user's input, and including a position related to the horizontal direction of the second object, as a first region related to the user, the region being a two-dimensional or three-dimensional region; and
limiting changing of the state of the virtual space in the first region without the user's input to change the state of the virtual space being performed.

23. An information processing method for causing one or more processors of an information processing system to at least:
change a state of a virtual space including at least a plurality of first objects by performing at least one of arrangement, movement, and removal of at least one of the first objects and a second object that is associated with each user, at, to, and from a position in the virtual space specified based on a user's input;
set, in the virtual space, a region having an extent in a horizontal direction set based on a height in the virtual space at which the second object associated with the user is arranged based on the user's input, and including a position related to the horizontal direction of the second object, as a first region related to the user, the region being a two-dimensional or three-dimensional region; and
limit changing of the state of the virtual space in the first region without the user's input to change the state of the virtual space being performed.
